(19) United States
(12) Patent Application Publication
(10) Pub. No.: US 2025/0284243 A1
(43) Pub. Date: Sep. 11, 2025

(54) Methods for Fabricating Optical Waveguides

(71) Applicant: DigiLens Inc., Sunnyvale, CA (US)

(72) Inventors: Jonathan David Waldern, Diablo, CA (US); Milan Momcilo Popovich, Leicester (GB); Alastair John Grant, San Jose, CA (US)

(73) Assignee: DigiLens Inc., Sunnyvale, CA (US)

(21) Appl. No.: 19/212,368

(22) Filed: May 19, 2025

Related U.S. Application Data
(63) Continuation of application No. 18/311,844, filed on May 3, 2023, now Pat. No. 12,306,585.
Application No. 18/311,844 is a continuation of application No. 17/107,442, filed on Nov. 30, 2020, now abandoned.
Application No. 17/107,442 is a continuation of application No. 16/242,966, filed on Jan. 8, 2019, now abandoned.
(60) Provisional application No. 62/614,932, filed on Jan. 8, 2018.

(51) Int. Cl. G03H 1/20; G02B 6/00; G02B 27/00; G02B 27/01; G03H 1/02; G03H 1/04

(52) U.S. Cl. CPC G03H 1/20; G02B 6/00; G02B 27/0081; G02B 27/0172; G03H 1/0248; G03H 1/0408; G02B 27/0093; G03H 2223/16; G03H 2260/00

(57) ABSTRACT

Mastering systems and methods of fabricating waveguides and waveguide devices using such mastering systems are described. Mastering systems for fabricating holographic waveguides can include using a master to control the application of energy (e.g. a laser, light, or magnetic beam) onto a liquid crystal substrate to fabricate a holographic waveguide into the liquid crystal substrate. Mastering systems for fabricating holographic waveguides in accordance with embodiments of the invention can include a variety of features. These features include, but are not limited to: chirp for single input beam copy (near i.e. hybrid contact copy), dual chirped gratings (for input and output), zero order grating for transmittance control, alignment reference gratings, 3:1 construction, position adjustment tooling to enable rapid alignment, optimization of lens and window thickness for multiple RKVs simultaneously, and avoidance of other orders and crossover of the diffraction beam.

### CROSS-REFERENCE TO RELATED APPLICATIONS

The current application is a continuation of U.S. patent application Ser. No. 18/311,844, entitled “Methods for Fabricating Optical Waveguides,” filed May 3, 2023 and published as US 2023-0359146 A1 on Nov. 9, 2023, which is a continuation of U.S. patent application Ser. No. 17/107,442 filed Nov. 30, 2020, which is a continuation of U.S. patent application Ser. No. 16/242,966 filed Jan. 8, 2019, which application claims the benefit of and priority under 35 U.S.C. § 119(e) to U.S. Provisional Patent Application No. 62/614,932 entitled “Methods for Fabricating Optical Waveguides,” filed Jan. 8, 2018, the disclosures of which are incorporated herein by reference in their entireties for all purposes.

### FIELD OF THE INVENTION

The present invention generally relates to methods for manufacture of waveguides and more specifically for waveguide displays.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (“TIR”).

Fabrication of waveguides can include the use of material systems that allow for the recording of holographic optical elements within the waveguides. One class of such material includes polymer dispersed liquid crystal (“PDLC”) mixtures, which are mixtures containing photopolymerizable monomers and liquid crystals. A further subclass of such mixtures includes holographic polymer dispersed liquid crystal (“HPDLC”) mixtures. Holographic optical elements, such as volume phase gratings, can be recorded in such a liquid mixture by illuminating the material with two mutually coherent laser beams. During the recording process, the monomers polymerize and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (“AR”) and virtual reality (“VR”), compact heads-up displays (“HUDs”) for aviation and road transport, and sensors for biometric and laser radar (“LIDAR”) applications.

### SUMMARY OF THE INVENTION

One embodiment includes a method for recording holograms, the method including providing a waveguide cell comprising a layer of polymer dispersed liquid crystal mixture sandwiched between two substrates, providing a master grating, emitting at least one recording beam toward the master grating, wherein upon interaction with the master grating, a portion of the at least one recording beam is diffracted towards the waveguide cell, and recording at least one volume grating within the waveguide cell using interferential exposure formed from at least the diffracted portion of the at least one recording beam.

A further embodiment again includes a system for recording holographic gratings, the system including a waveguide cell including a layer of polymer dispersed liquid crystal mixture sandwiched between two substrates, a master grating, a light source configured to emit at least one recording beam toward the master grating, wherein upon interaction with the master grating, a portion of the at least one recording beam is diffracted towards the waveguide cell and at least one volume grating is recorded within the waveguide cell through interferential exposure formed from at least the diffracted portion of the at least one recording beam.

In another embodiment, the master grating includes an amplitude grating.

In a further embodiment, the master grating includes a chirped grating.

In still another embodiment, the recorded volume grating contains a rolled K-vector.

In a still further embodiment, the recorded volume grating contains a multiplexed grating.

In yet another embodiment, the master grating includes three separate gratings.

In a yet further embodiment, the three separate gratings are designed to record an input grating, a fold grating, and an output grating.

In another additional embodiment, the at least one volume grating includes three volume gratings.

In a further additional embodiment, the at least one recording beam includes three recording beams.

In another embodiment again, the interferential exposure is formed from the zero order beam and diffracted portion of only one recording beam.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as exemplary embodiments of the invention and should not be construed as a complete recitation of the scope of the invention. It will apparent to those skilled in the art that the present invention may be practiced with some or all of the present invention as disclosed in the following description.

FIGS. 1A and 1B conceptually illustrate two volume Bragg grating configurations in accordance with various embodiments of the invention.

FIG. 2 conceptually illustrates a surface relief grating in accordance with an embodiment of the invention.

FIGS. 3A and 3B conceptually illustrate HPDLC SBG devices and the switching property of SBGs in accordance with various embodiments of the invention.

FIGS. 4A-4D conceptually illustrate two-beam recording processes in accordance with various embodiments of the invention.

FIG. 5 conceptually illustrates a single-beam recording process utilizing an amplitude grating in accordance with an embodiment of the invention.

FIGS. 6A and 6B conceptually illustrate two implementations of rolled K-vector gratings in accordance with various embodiments of the invention.

FIG. 7 conceptually illustrates a multiplexed K-vector grating in accordance with an embodiment of the invention.

FIG. 8 conceptually illustrates a waveguide utilizing coupling gratings to diffract light into and out of the waveguide in accordance with an embodiment of the invention.

FIGS. 9 and 10 conceptually illustrate waveguides utilizing an output grating for exit pupil expansion in one dimension in accordance with an embodiment of the invention.

FIG. 11 conceptually illustrates a waveguide system utilizing two planar waveguides to provide exit pupil expansion in two dimensions in accordance with an embodiment of the invention.

FIG. 12 conceptually illustrates a waveguide utilizing a three-grating structure to provide two dimensional exit pupil expansion in accordance with an embodiment of the invention.

FIG. 13 conceptually illustrates a profile view of an RGB stack of waveguides in accordance with an embodiment of the invention.

FIG. 14 conceptually illustrates a dual axis expansion waveguide display with two grating layers in accordance with an embodiment of the invention.

FIG. 15 conceptually illustrates a plan view of a single grating layer in accordance with an embodiment of the invention.

FIG. 16 conceptually illustrates a plan view of a two grating layer configuration in accordance with an embodiment of the invention.

FIG. 17 conceptually illustrates a dual axis expansion waveguide display in accordance with an embodiment of the invention.

FIG. 18 conceptually illustrates an eye tracker display in accordance with an embodiment of the invention.

FIG. 19 conceptually illustrates a dual expansion waveguide display with a dynamic focusing element and an eye tracker in accordance with an embodiment of the invention.

FIGS. 20A and 20B conceptually illustrate a waveguide display coupled to an input image node by an opto-mechanical interface in accordance with an embodiment of the invention.

FIGS. 21-24 conceptually illustrate various input image node configurations in accordance with various embodiments of the invention.

FIG. 25 conceptually illustrates a system diagram showing components for waveguide displays in accordance with an embodiment of the invention.

FIG. 26 conceptually illustrates an exposure process utilizing a chirped amplitude grating in accordance with an embodiment of the invention.

FIGS. 27A and 27B conceptually illustrate an exposure process for forming three gratings simultaneously in accordance with an embodiment of the invention.

FIG. 28 conceptually illustrates a fabrication setup for exposing red, blue, and green gratings simultaneously in accordance with an embodiment of the invention.

FIGS. 29A-29C conceptual illustrate a variety of approaches for generating RKV gratings in accordance with various embodiments of the invention.

FIGS. 30A and 30B conceptually illustrate various applications of chirped gratings in accordance with various embodiments of the invention.

FIG. 31 conceptually illustrates a mastering system utilizing a zero order grating along with a chirped grating in accordance with an embodiment of the invention.

FIG. 32 conceptually illustrates a mastering system utilizing reference gratings in accordance with an embodiment of the invention.

FIG. 33 conceptually illustrates a mastering system configured to avoid other order beams from being created and/or interfering with the energy beam being focused on the liquid crystal substrate in accordance with an embodiment of the invention.

FIG. 34 conceptually illustrates the effect of positioning of the master grating on the resulting diffraction.

### DETAILED DESCRIPTION

For the purposes of describing embodiments, some well-known features of optical technology known to those skilled in the art of optical design and visual displays have been omitted or simplified in order to not obscure the basic principles of the invention. Unless otherwise stated the term “on-axis” in relation to a ray or a beam direction refers to propagation parallel to an axis normal to the surfaces of the optical components described in relation to the invention. In the following description the terms light, ray, beam, and direction may be used interchangeably and in association with each other to indicate the direction of propagation of electromagnetic radiation along rectilinear trajectories. The term light and illumination may be used in relation to the visible and infrared bands of the electromagnetic spectrum. Parts of the following description will be presented using terminology commonly employed by those skilled in the art of optical design. As used herein, the term grating may encompass a grating comprised of a set of gratings in some embodiments. For illustrative purposes, it is to be understood that the drawings are not drawn to scale unless stated otherwise.

Turning now to the drawings, mastering systems and methods of fabricating waveguides and waveguide devices using such mastering systems are described. Mastering systems for fabricating holographic waveguides can include using a master to control the application of energy (e.g. a laser, light, or magnetic beam) onto a liquid crystal substrate to fabricate a holographic waveguide into the liquid crystal substrate. After fabrication, the finished holographic waveguide can be incorporated into a variety of display systems. These mastering systems can employ one or more energy beams. In many embodiments, the mastering system uses a single energy beam, which can simplify the alignment of the various components within the mastering system and can reduce wave front error found in two-beam systems caused by the different paths of the two beams. As such, single energy beam processes can be compatible with high volume manufacturing processes where thermal and vibrational considerations can introduce a variety of complications in aligning multiple energy beams. Mastering systems for fabricating holographic waveguides in accordance with embodiments of the invention can include a variety of features. These features include, but are not limited to: chirp for single input beam copy (near i.e. hybrid contact copy), dual chirped gratings (for input and output), zero order grating for transmittance control, alignment reference gratings, 3:1 construction, position adjustment tooling to enable rapid alignment, optimization of lens and window thickness for multiple rolled K-vector gratings simultaneously, and avoidance of other orders and crossover of the diffraction beam. Waveguide structures, mastering systems, and exposure processes are described in the sections below in further detail.

### Waveguide Structures

Waveguide structures in accordance with various embodiments can be implemented in many different ways. In many embodiments, the waveguide structures are designed to be optical waveguides, which are structures that can confine and guide electromagnetic waves in the visible spectrum, or light. These optical waveguides can be implemented for use in a number of different applications, such as but not limited to helmet mounted displays, head mounted displays (“HMDs”), and HUDs. The term HUD is typically utilized to describe a class of devices that incorporates a transparent display that presents data without requiring users to change their usual visual field. Optical waveguides can integrate various optical functions into a desired form factor depending on the given application.

Optical waveguides in accordance with various embodiments can be designed to manipulate light waves in a controlled manner using various methods and waveguide optics. For example, optical waveguides can be implemented using materials with higher refractive indices than the surrounding environment to restrict the area in which light can propagate. Light coupled into optical waveguides made of such materials at certain angles can be confined within the waveguide via total internal reflection. In a planar waveguide, the angles at which total internal reflection occurs can be given by Snell's law, which can determine whether the light is refracted or entirely reflected at the surface boundary.

In many embodiments, waveguides incorporating Bragg gratings are implemented for HUD applications. HUDs can be incorporated in any of a variety of applications including (but not limited to) near-eye applications. HUDs that utilize planar waveguides incorporating Bragg gratings in accordance with various embodiments of the invention can achieve significantly larger fields of view and have lower volumetric requirements than HUDs implemented using conventional optical components. In some embodiments, the HUDs include at least one waveguide incorporating a number of gratings. In further embodiments, the waveguide incorporates at least three Bragg gratings that can be implemented to provide various optical functions, such as but not limited to dual-axis beam expansion. For example, in a number of embodiments, the waveguide incorporates an input grating, a fold grating, and an output grating. HUDs utilizing waveguides can be implemented using varying numbers of waveguide. In many embodiments, a HUD is implemented using a single waveguide. In other embodiments, the HUD is implemented using a stack of waveguides. Multiple waveguides can be stacked and implemented to provide different optical functions, such as but not limited to implementing color displays. In several embodiments, the HUDs incorporate three separate waveguides, one waveguide for each of a Red, Green, and Blue color channel.

Waveguides utilizing Bragg gratings in accordance with various embodiments of the invention can be designed to have different types of fringes. Use of multiple waveguides having the same surface pitch sizes but different grating slanted angles can increase the overall couple-in angular bandwidth of the waveguide. In a number of embodiments, one or more of the gratings within the waveguide incorporate a rolling K-vector and/or a slant angle that varies across the grating to modify the diffraction efficiency of the grating. The K-vector can be defined as a vector orthogonal to the plane of the associated grating fringe, which can determine the optical efficiency for a given range of input and diffracted angles. By incorporating a grating with rolled K-vectors (“RKVs”), the gratings can be designed to vary diffraction efficiency in a manner that achieves desirable characteristics across the eyebox of the HUD display. Configurations of grating fringes (such as RKVs) and other aspects relating to the structures and implementations of waveguides for use in HUDs are discussed below in further detail.

### Diffraction Gratings

Optical waveguides can incorporate different optical elements to manipulate the propagation of light waves. As can readily be appreciated, the type of grating selected can depend on the specific requirements of a given application. Optical structures recorded in waveguides can include many different types of optical elements, such as but not limited to diffraction gratings. In many embodiments, the grating implemented is a Bragg grating (also referred to as a volume grating). Bragg gratings can have high efficiency with little light being diffracted into higher orders. The relative amount of light in the diffracted and zero order can be varied by controlling the refractive index modulation of the grating, a property that is can be used to make lossy waveguide gratings for extracting light over a large pupil. By strategically placing volume Bragg gratings within a waveguide, the propagation of light within the waveguide can be affected in a controlled manner to achieve various effects. The diffraction of light incident on the grating can be determined by the characteristic of the light and the grating. As can readily be appreciated, volume Bragg gratings can be constructed to have different characteristics depending on the specific requirements of the given application. In a number of embodiments, the volume Bragg grating is designed to be a transmission grating. In other embodiments, the volume Bragg grating is designed to be a reflection grating. In transmission gratings, incident light meeting the Bragg condition is diffracted such that the diffracted light exits the grating on the side which the incident light did not enter. For reflection gratings, the diffracted light exits on the same side of the grating as where the incident light entered.

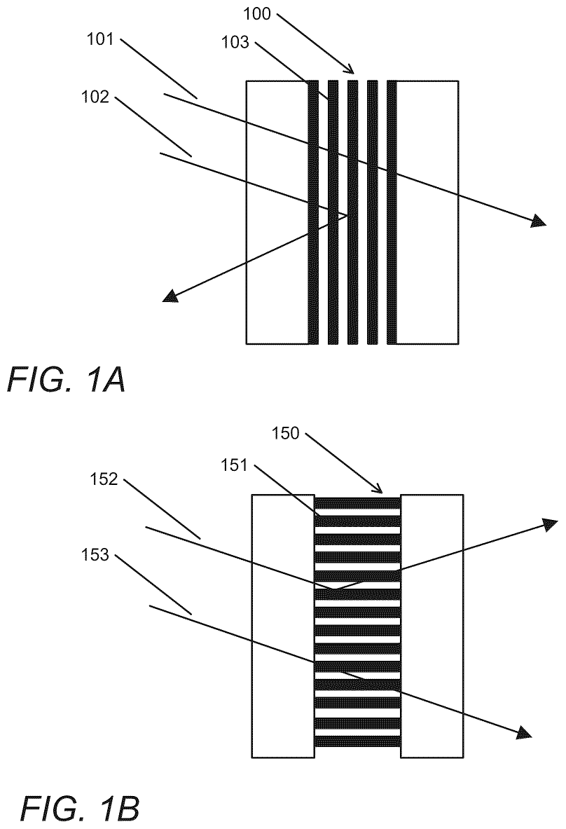

FIGS. 1A and 1B conceptually illustrate two volume Bragg grating configurations in accordance with various embodiments of the invention. Depending on the side out of which a light ray exits after diffraction, the grating can be classified as either a reflection grating 100 or a transmission grating 150. The conditions for refraction/reflection, or Bragg condition, can depend several factors, such as but not limited to the refractive indices of the medium, the grating period, the wavelength of the incident light, and the angle of incidence. FIG. 1A shows a reflection grating 100 recorded in a transparent material. As shown, light rays 101, 102 are of different wavelengths and are incident at the same angle on the reflection grating 100, which has fringes 103 that are parallel to the grating surface. Light ray 101 does not meet the Bragg condition and is transmitted through the grating. On the other hand, light ray 102 does meet the Bragg condition and is reflected back through the same surface on which it entered. Another type of grating is a transmission grating, which is conceptually illustrated in FIG. 1B. In the illustrative embodiment, the transmission grating 150 has fringes 151 that are perpendicular to the grating surface. As shown, light rays 152, 153 with different wavelengths are incident on the transmission grating 150 at the same angle. Light ray 152 meets the Bragg condition and is refracted, exiting on the opposite side of the grating on which the light ray 152 entered. Light ray 153 does not meet the Bragg condition and is transmitted through with its original path of propagation. Depending on the efficiency of the grating, light can be partially reflected or refracted. Although FIGS. 1A and 1B illustrate specific volume grating structures, any type of grating structure can be recorded in a waveguide cell in accordance with various embodiments of the invention. For example, volume gratings can be implemented with fringes that are tilted and/slanted relative to the grating surface, which can affect the angles of diffraction/reflection. Although the discussions above denote the grating structures as either transmission or reflection, both types of gratings behave in the same manner according to the standard grating equation.

Waveguide structures in accordance with various embodiments of the invention can implement gratings in a number of different ways. In addition to volume gratings, gratings can be implemented as surface relief gratings. As the name suggests, surface relief gratings can be implemented by physically forming grooves or periodic patterns on the surface of the substrate. The periodicity and angles formed by the grooves can determine the efficiency and other characteristics of the grating. Any of a number of methods can be used to form these grooves, such as but not limited to etching and photolithography.

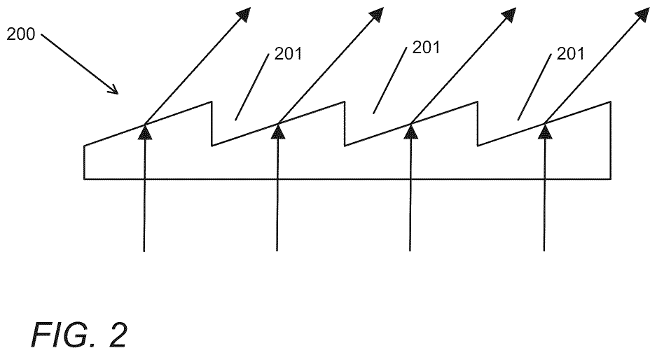

FIG. 2 conceptually illustrates a surface relief grating in accordance with an embodiment of the invention. As shown, the surface relief grating 200 contains periodic slanted grooves 201. When light is incident on the grooves 201, diffraction can occur under certain conditions. The slant and periodicity of the grooves 201 can be designed to achieve targeted diffraction behavior of incident light.

Although FIGS. 1A-1B and 2 show specific grating structures, it is readily appreciable that grating structures can be configured in a number of different ways depending on the specific requirements of a given application. Examples of such configurations are discussed in the sections below in further detail.

### Switchable Bragg Gratings

One class of gratings used in holographic waveguide devices is the Switchable Bragg Grating (“SBG”). SBGs can be fabricated by first placing a thin film of a mixture of photopolymerizable monomers and liquid crystal material between glass plates or substrates. In many cases, the glass plates are in a parallel configuration. One or both glass plates can support electrodes, typically transparent tin oxide films, for applying an electric field across the film. The grating structure in an SBG can be recorded in the liquid material (often referred to as the syrup) through photopolymerization-induced phase separation using interferential exposure with a spatially periodic intensity modulation. Factors such as but not limited to control of the irradiation intensity, component volume fractions of the materials in the mixture, and exposure temperature can determine the resulting grating morphology and performance. As can readily be appreciated, a wide variety of materials and mixtures can be used depending on the specific requirements of a given application. In many embodiments, HPDLC material is used. During the recording process, the monomers polymerize and the mixture undergoes a phase separation. The LC molecules aggregate to form discrete or coalesced droplets that are periodically distributed in polymer networks on the scale of optical wavelengths. The alternating liquid crystal-rich and liquid crystal-depleted regions form the fringe planes of the grating, which can produce Bragg diffraction with a strong optical polarization resulting from the orientation ordering of the LC molecules in the droplets.

The resulting volume phase grating can exhibit very high diffraction efficiency, which can be controlled by the magnitude of the electric field applied across the film. When an electric field is applied to the grating via transparent electrodes, the natural orientation of the LC droplets can change, causing the refractive index modulation of the fringes to lower and the hologram diffraction efficiency to drop to very low levels. Typically, the electrodes are configured such that the applied electric field will be perpendicular to the substrates. In a number of embodiments, the electrodes are fabricated from indium tin oxide (“ITO”). In the OFF state with no electric field applied, the extraordinary axis of the liquid crystals generally aligns normal to the fringes. The grating thus exhibits high refractive index modulation and high diffraction efficiency for P-polarized light. When an electric field is applied to the HPDLC, the grating switches to the ON state wherein the extraordinary axes of the liquid crystal molecules align parallel to the applied field and hence perpendicular to the substrate. In the ON state, the grating exhibits lower refractive index modulation and lower diffraction efficiency for both S- and P-polarized light. Thus, the grating region no longer diffracts light. Each grating region can be divided into a multiplicity of grating elements such as for example a pixel matrix according to the function of the HPDLC device. Typically, the electrode on one substrate surface is uniform and continuous, while electrodes on the opposing substrate surface are patterned in accordance to the multiplicity of selectively switchable grating elements.

Typically, the SBG elements are switched clear in 30 μs with a longer relaxation time to switch ON. Note that the diffraction efficiency of the device can be adjusted, by means of the applied voltage, over a continuous range. In many cases, the device exhibits near 100% efficiency with no voltage applied and essentially zero efficiency with a sufficiently high voltage applied. In certain types of HPDLC devices, magnetic fields can be used to control the LC orientation. In some HPDLC applications, phase separation of the LC material from the polymer can be accomplished to such a degree that no discernible droplet structure results. An SBG can also be used as a passive grating. In this mode, its chief benefit is a uniquely high refractive index modulation. SBGs can be used to provide transmission or reflection gratings for free space applications. SBGs can be implemented as waveguide devices in which the HPDLC forms either the waveguide core or an evanescently coupled layer in proximity to the waveguide. The glass plates used to form the HPDLC cell provide a total internal reflection (“TIR”) light guiding structure. Light can be coupled out of the SBG when the switchable grating diffracts the light at an angle beyond the TIR condition.

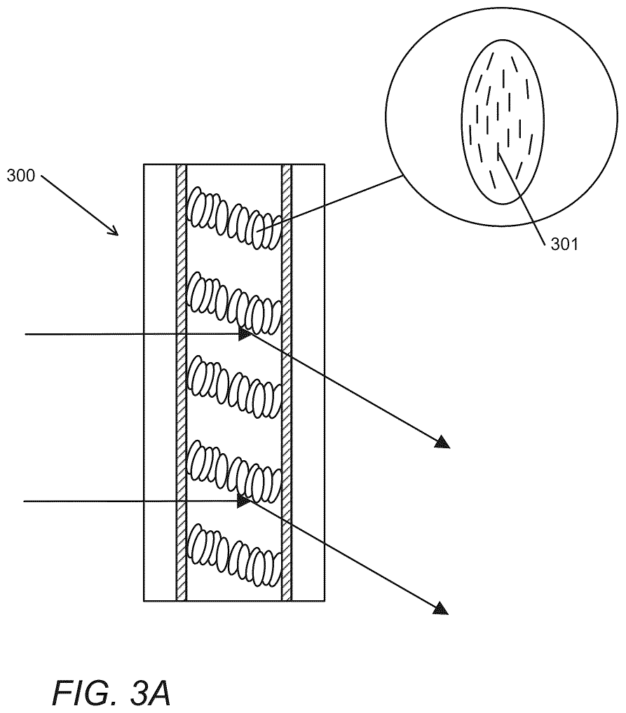

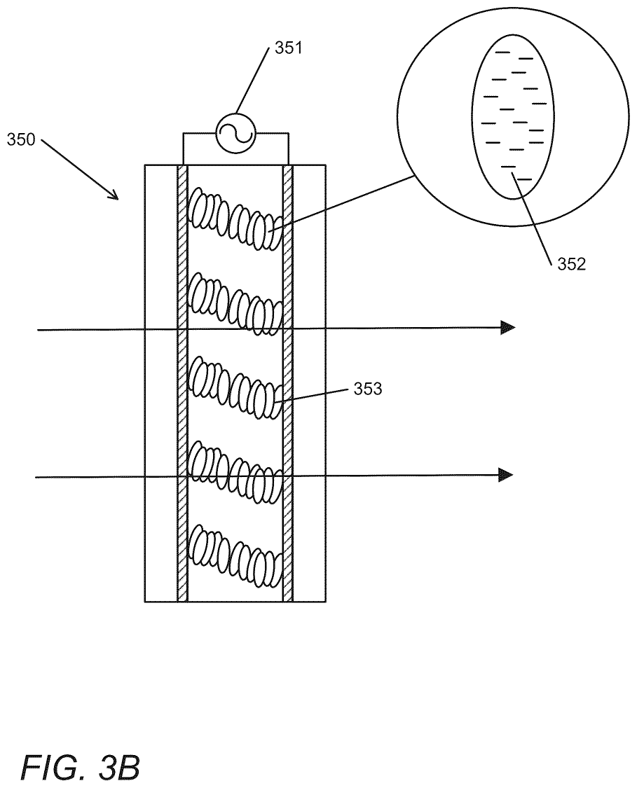

FIGS. 3A and 3B conceptually illustrate HPDLC SBG devices 300, 350 and the switching property of SBGs in accordance with various embodiments of the invention. In FIG. 3A, the SBG 300 is in an OFF state. As shown, the LC molecules 301 are aligned substantially normal to the fringe planes. As such, the SBG 300 exhibits high diffraction efficiency, and incident light can easily be diffracted. FIG. 3B illustrates the SBG 350 in an ON position. An applied voltage 351 can orient the optical axis of the LC molecules 352 within the droplets 353 to produce an effective refractive index that matches the polymer's refractive index, essentially creating a transparent cell where incident light is not diffracted. In the illustrative embodiment, an AC voltage source is shown. As can readily be appreciated, various voltage sources can be utilized depending on the specific requirements of a given application.

In waveguide cell designs, in addition to the components described above, adhesives and spacers can be disposed between the substrates to affix the layers of the elements together and to maintain the cell gap, or thickness dimension. In these devices, spacers can take many forms, such as but not limited to materials, sizes, and geometries. Materials can include, for example, plastics (e.g., divinylbenzene), silica, and conductive spacers. They can take any suitable geometry, such as but not limited to rods and spheres. The spacers can take any suitable size. In many cases, the sizes of the spacers range from 1 to 30 μm. While the use of these adhesive materials and spacers can be necessary in LC cells using conventional materials and methods of manufacture, they can contribute to the haziness of the cells degrading the optical properties and performance of the waveguide and device.

### HPDLC Material Systems

HPDLC mixtures in accordance with various embodiments of the invention generally include LC, monomers, photoinitiator dyes, and coinitiators. The mixture (often referred to as syrup) frequently also includes a surfactant. For the purposes of describing the invention, a surfactant is defined as any chemical agent that lowers the surface tension of the total liquid mixture. The use of surfactants in PDLC mixtures is known and dates back to the earliest investigations of PDLCs. For example, a paper by R.L Sutherland et al., SPIE Vol. 2689, 158-169, 1996, the disclosure of which is incorporated herein by reference, describes a PDLC mixture including a monomer, photoinitiator, coinitiator, chain extender, and LCs to which a surfactant can be added. Surfactants are also mentioned in a paper by Natarajan et al, Journal of Nonlinear Optical Physics and Materials, Vol. 5 No. 1 89-98, 1996, the disclosure of which is incorporated herein by reference. Furthermore, U.S. Pat. No. 7,018,563 by Sutherland; et al., discusses polymer-dispersed liquid crystal material for forming a polymer-dispersed liquid crystal optical element comprising: at least one acrylic acid monomer; at least one type of liquid crystal material; a photoinitiator dye; a coinitiator; and a surfactant. The disclosure of U.S. Pat. No. 7,018,563 is hereby incorporated by reference in its entirety.

The patent and scientific literature contains many examples of material systems and processes that can be used to fabricate SBGs, including investigations into formulating such material systems for achieving high diffraction efficiency, fast response time, low drive voltage, and so forth. U.S. Pat. No. 5,942,157 by Sutherland, and U.S. Pat. No. 5,751,452 by Tanaka et al. both describe monomer and liquid crystal material combinations suitable for fabricating SBG devices. Examples of recipes can also be found in papers dating back to the early 1990s. Many of these materials use acrylate monomers, including:
R. L. Sutherland et al., Chem. Mater. 5, 1533 (1993), the disclosure of which is incorporated herein by reference, describes the use of acrylate polymers and surfactants. Specifically, the recipe comprises a crosslinking multifunctional acrylate monomer; a chain extender N-vinyl pyrrolidinone, LC E7, photo-initiator rose Bengal, and coinitiator N-phenyl glycine. Surfactant octanoic acid was added in certain variants.
Fontecchio et al., SID 00 Digest 774-776, 2000, the disclosure of which is incorporated herein by reference, describes a UV curable HPDLC for reflective display applications including a multi-functional acrylate monomer, LC, a photoinitiator, a coinitiators, and a chain terminator.
Y.H. Cho, et al., Polymer International, 48, 1085-1090, 1999, the disclosure of which is incorporated herein by reference, discloses HPDLC recipes including acrylates.
Karasawa et al., Japanese Journal of Applied Physics, Vol. 36, 6388-6392, 1997, the disclosure of which is incorporated herein by reference, describes acrylates of various functional orders.
T.J. Bunning et al., Polymer Science: Part B: Polymer Physics, Vol. 35, 2825-2833, 1997, the disclosure of which is incorporated herein by reference, also describes multifunctional acrylate monomers.
G.S. lannacchione et al., Europhysics Letters Vol. 36 (6). 425-430, 1996, the disclosure of which is incorporated herein by reference, describes a PDLC mixture including a penta-acrylate monomer, LC, chain extender, coinitiators, and photoinitiator.

Acrylates offer the benefits of fast kinetics, good mixing with other materials, and compatibility with film forming processes. Since acrylates are cross-linked, they tend to be mechanically robust and flexible. For example, urethane acrylates of functionality 2 (di) and 3 (tri) have been used extensively for HPDLC technology. Higher functionality materials such as penta and hex functional stems have also been used.

One of the known attributes of transmission SBGs is that the LC molecules tend to align with an average direction normal to the grating fringe planes (i.e., parallel to the grating or K-vector). The effect of the LC molecule alignment is that transmission SBGs efficiently diffract P polarized light (i.e., light with a polarization vector in the plane of incidence), but have nearly zero diffraction efficiency for S polarized light (i.e., light with the polarization vector normal to the plane of incidence).

### Recording Mechanisms for Volume Gratings

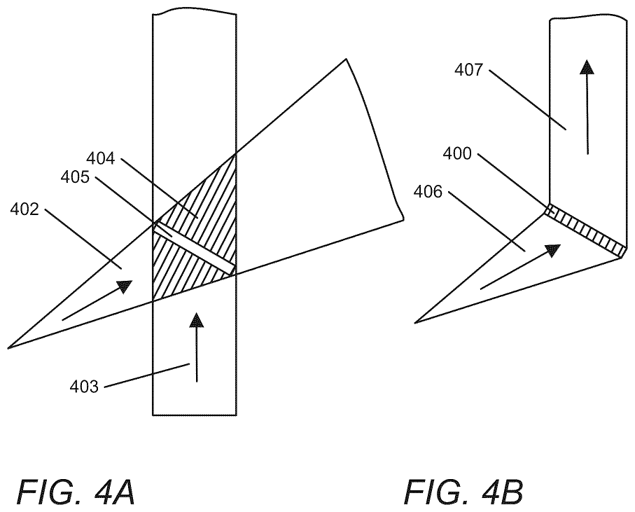

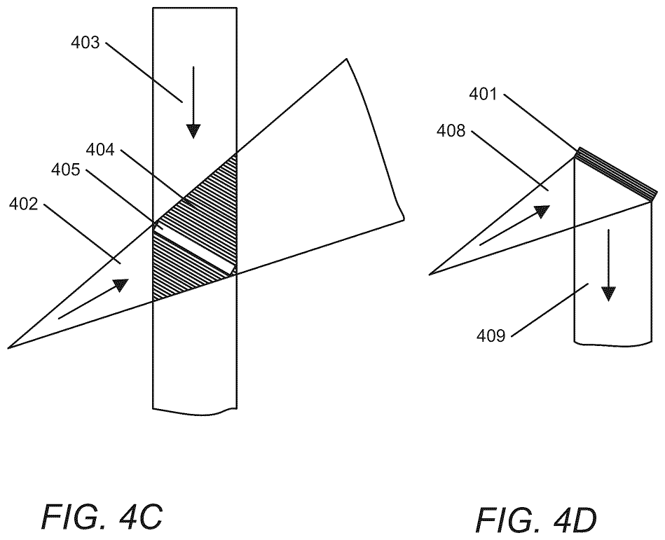

Volume gratings can be recorded in a waveguide cell using many different methods in accordance with various embodiments of the invention. The recording of optical elements in optical recording materials can be achieved using any number and type of electromagnetic radiation sources. Depending on the application, the exposure source(s) and/or recording system can be configured to record optical elements using varying levels of exposure power and duration. As discussed above with regards to SBGs, techniques for recording volume gratings can include the exposure of an optical recording material using two mutually coherent laser beams, where the superimposition of the two beams create a periodic intensity distribution along the interference pattern. The optical recording material can form grating structures exhibiting a refractive index modulation pattern matching the periodic intensity distribution. In HPDLC mixtures, the light intensity distribution results in diffusion and polymerization of monomers into the high intensity regions and simultaneous diffusion of liquid crystal into the dark regions. This phase separation creates alternating liquid crystal-rich and liquid crystal-depleted regions that form the fringe planes of the grating. The grating structures can be formed with slanted or non-slanted fringes depending on how the recording beams are configured. FIGS. 4A-4D conceptually illustrate two-beam recording processes in accordance with various embodiments of the invention. As shown, two methods can be used to create two different types of Bragg gratings—i.e., a transmission grating 400 and a reflection grating 401. Depending on how the two recording beams 402, 403 are positioned, the interference pattern 404 can record either a transmission or a reflection grating in an optical recording material 405. Differences between the two types of gratings can be seen in the orientation of the fringes (i.e., the fringes of a reflection volume grating are typically substantially parallel to the surface of the substrate, and the fringes of a transmission grating are typically substantially perpendicular to the surface of the substrate). During playback, a beam 406 incident on the transmission grating 400 can result in a diffracted beam 407 that is transmitted. On the other hand, a beam 408 that is incident on the reflection grating 401 can result in a beam 409 that is reflected.

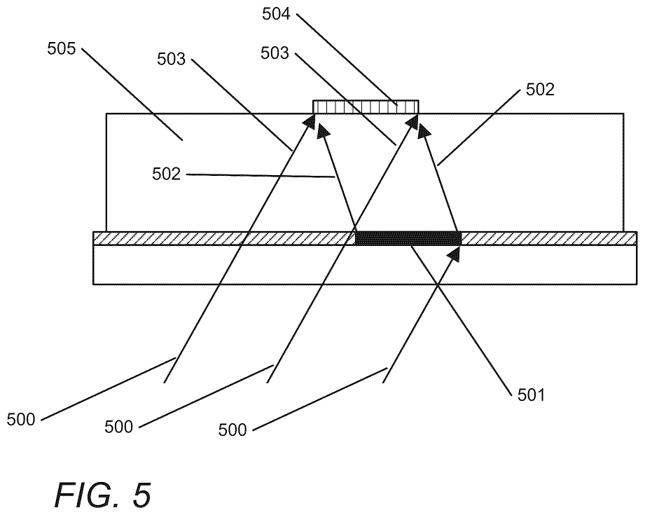

Another method for recording volume gratings in an optical recording material includes the use of a single beam to form an interference pattern onto the optical recording material. This can be achieved through the use of a master grating. In many embodiments, the master grating is a volume grating. In some embodiments, the master grating is an amplitude grating. Upon interaction with the master grating, the single beam can diffract. The first order diffraction and the zero order beam can overlap to create an interference pattern, which can then expose the optical recording material to form the desired volume grating. A single-beam recording process utilizing an amplitude grating in accordance with an embodiment of the invention is conceptually illustrated in FIG. 5. As shown, a beam 500 from a single laser source (not shown) is directed through an amplitude grating 501. Upon interaction with the grating 501, the beam 500 can diffract as, for example, in the case of the rays interacting with the black shaded region of the amplitude grating, or the beam 500 can propagated through the amplitude grating without substantial deviation as a zero-order beam as, for example, in the case of the rays interacting with the cross-hatched region of the amplitude grating. The first order diffraction beams 502 and the zero order beams 503 can overlap to create an interference pattern that exposes the optical recording layer 504 of a waveguide cell. In the illustrative embodiment, a spacer block 505 is positioned between the grating 501 and the optical recording layer 504 in order to alter the distance between the two components.

Although specific methods of recording volume gratings are discussed and shown in FIGS. 4A-4D and 5, recording systems in accordance with various embodiments of the invention can be configured to implement any of a number of methods for recording volume gratings.

### Rolled K-Vector Gratings and Multiplexed K-Vector Gratings

In addressing the limited range of wavelengths and angles over which diffraction occurs in volume Bragg gratings, several methods can be utilized to increase the diffraction bandwidth of the gratings. In many embodiments, gratings can employ fringes that vary with respect to their K-vectors. In a number of embodiments, the change across the rolled K-vectors is typically such that the direction of the change in K-vectors is out of plane with the waveguide or grating element. Varying fringes, or rolled K-vectors, can be implemented in a number of different ways. In some embodiments, fringes of gratings are designed to vary in a progressive manner across the grating. In other embodiments, different discrete sets of gratings with different fringes are place serially. Gratings with rolled K-vectors can be designed and configured in a variety of ways. In many embodiments, the rolled K-vectors are designed such that the peak diffraction efficiency of each grating segment is optimized for its corresponding output angle at that position. In some embodiments, the peak diffraction efficiency of each grating at different positions is at an offset with its corresponding output angle at that position. It has been shown that by introducing this offset, eyebox homogeneity can be improved. In several embodiments, offsets can improve total image brightness by a factor of two compared to just matching the peak diffraction efficiencies at different positions.

Rolled K-vector gratings can be used to maximize the peak diffraction efficiency of in-couple light in accordance with an embodiment of the invention. The use of rolled k-vectors enables high efficiency input coupling into a grating, and also allows the beam spread angle to be optimized to minimize the thickness of the waveguide; this may need balancing the waveguide thickness, the angular bandwidth of the grating, and the spread of field angles at any given point on the grating. The low angular response of gratings as the K-vector is rolled (and surface pitch maintained) can prevent output coupling, allowing the waveguide thickness to be minimized. In a number of embodiments, the design aim is to ensure maximum input coupling at a point and to minimize the angular diversity such that the grating thickness can be minimized without reciprocally out-coupling at different point.

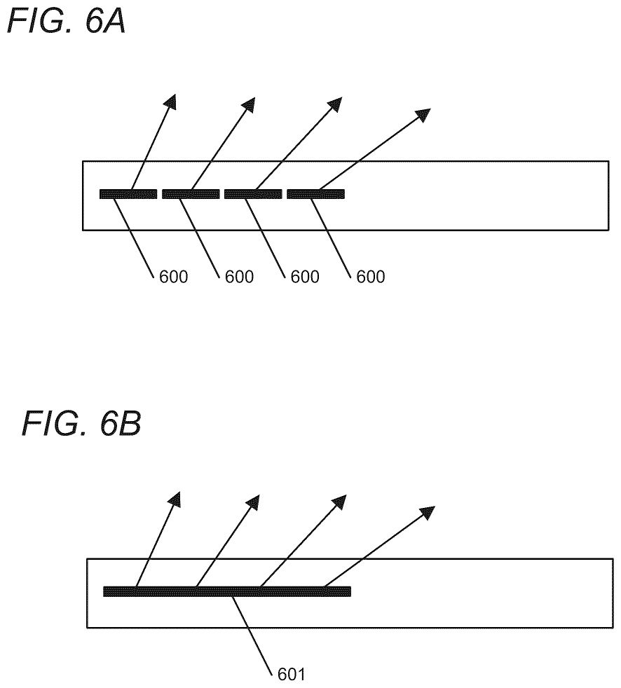

FIGS. 6A and 6B conceptually illustrate two implementations of rolled K-vector gratings in accordance with various embodiments of the invention. Referring first to FIG. 6A, in some embodiments a rolled K-vector grating can be implemented as a waveguide portion containing discrete grating elements 600 having different K-vectors. Referring next to FIG. 6B, in several embodiments a rolled K-vector grating can be implemented as a waveguide portion containing grating elements 601 within which the K-vectors undergoes a smooth monotonic variation in direction. As illustrated, the change in the direction of the K-vectors is out of plane with the waveguide.

In many embodiments, different sets of discrete fringes are superimposed into the same grating, creating a multiplexed grating with essentially multiple gratings inside the same volume that work independently and without interfering with each other. For example, if two volume gratings are recorded in the same device for two different Bragg wavelengths at the same incidence angle, the device can diffract the two selected wavelengths into different output directions with limited crosstalk. Multiplexing can be used to produce improved angular profiles by combining two gratings of similar prescription to extend the diffraction efficiency angular bandwidth and give better luminance uniformity and color balance across the exit pupil and field of view. Multiplexing can also be used to encode two distinct diffraction prescriptions which can be design to project light into distinct field of regions or diffract light of two different wavelengths into a given field of view region. Steps can be taken to ensure that there is no competition between gratings during recording leading to unequal diffraction efficiencies and crosstalk between gratings in playback. Multiplexing can also offer the significant benefit of reducing the number of layers in the waveguide structure. In some embodiments, at least one of the input, fold, or output gratings can combine two or more angular diffraction prescriptions to expand the angular bandwidth. Similarly, in several embodiments, at least one of the input, fold, or output gratings can combine two or more spectral diffraction prescriptions to expand the spectral bandwidth. For example, a color multiplexed grating may be used to diffract two or more of the primary colors.

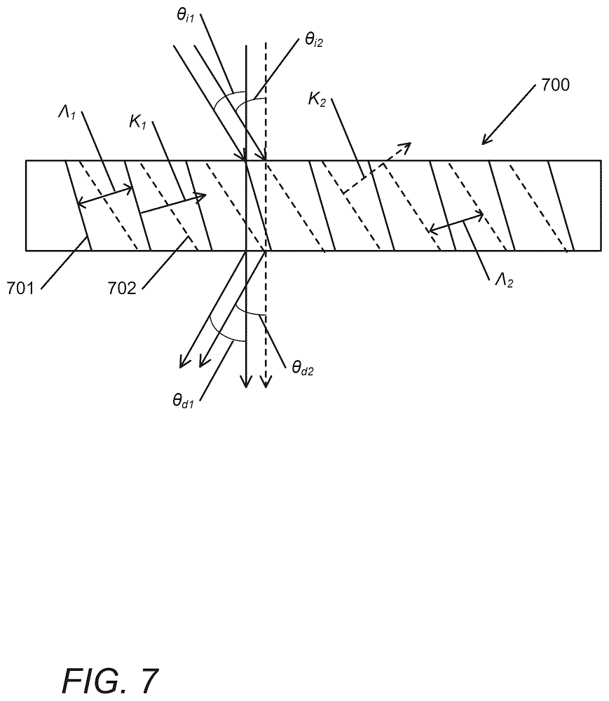

FIG. 7 conceptually illustrates a multiplexed K-vector grating in accordance with an embodiment of the invention. As illustrated, the multiplexed grating 700 contains two sets of fringes 701, 702. The first set 701 is depicted by solid diagonal lines and has K-vector K₁ and period Λ₁. The second multiplexed grating 702 is illustrated by dot-dash lines and has K-vector K₂ and period Λ₂. In the illustrated embodiment, the two grating periods are the same, but the K-vectors differ in direction. In operation, both of the multiplexed gratings 701, 702 are active and can provide broader incidence and diffraction bandwidths. The angular bandwidth of incidence θᵢ for the multiplexed gratings covers the angular range including the overlapping θᵢ₁ and θᵢ₂. The angular bandwidth of diffraction θ_{d} for the multiplexed gratings 701, 702 covers the angular range including the overlapping θ_{d1} and θ_{d2}. In some embodiments, more than two gratings are multiplexed.

Although specific grating structures with varying fringes are discussed above, any of a number of fringe configurations can be utilized in accordance with specific requirements of a given application. For example, any number of gratings can be multiplexed as allowed by manufacturing constraints. Rolled K-vector gratings can be designed to have K-vectors rolled in any discrete unit.

### Waveguides Implementing Pupil Expansion

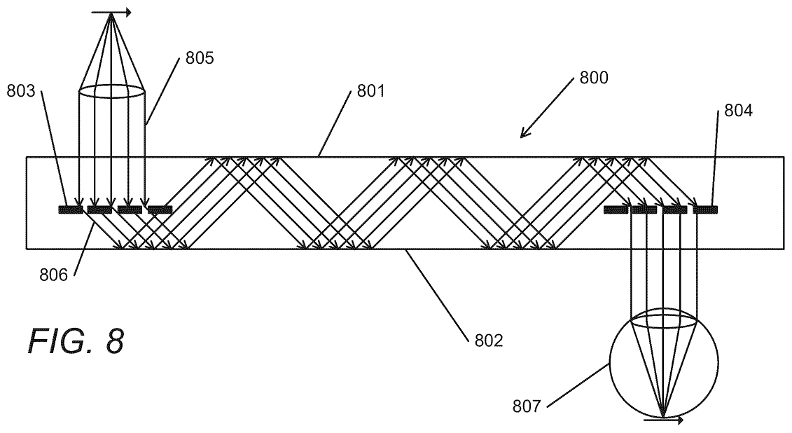

Gratings can be implemented in waveguides in a variety of different ways. In some embodiments, the gratings reside on the outer surface of the waveguide. In other embodiments, volume gratings are implemented inside the waveguide. Gratings can also be implemented to perform different optical functions, such as but not limited to coupling light, directing light, and preventing the transmission of light. FIG. 8 conceptually illustrates a waveguide utilizing coupling gratings to diffract light into and out of the waveguide in accordance with an embodiment of the invention. As shown, the waveguide 800 includes a first surface 801, a second surface 802, an input grating element 803, and an output grating element 804. Collimated light 805 from a projection lens enters the waveguide through the first surface 801 at an orthogonal angle. The light travels through the waveguide 800 at its original angle and, before reaching the second surface 802 at the other side of the waveguide 800, interacts with an input grating element 803. The input grating element 803 can be designed to diffract the light 805 at an oblique angle such that the refracted light 806 is incident on the second surface 802 at an angle at which total internal reflection can occur. As such, the light 805 is coupled into the waveguide and is confined within the first and second surfaces 801, 802 of the waveguide 800. In the illustrative embodiment, the light travels within the waveguide 800 until it interacts with an output grating 804, which refracts and couples the light out of the waveguide 800 and into a user's eye 807.

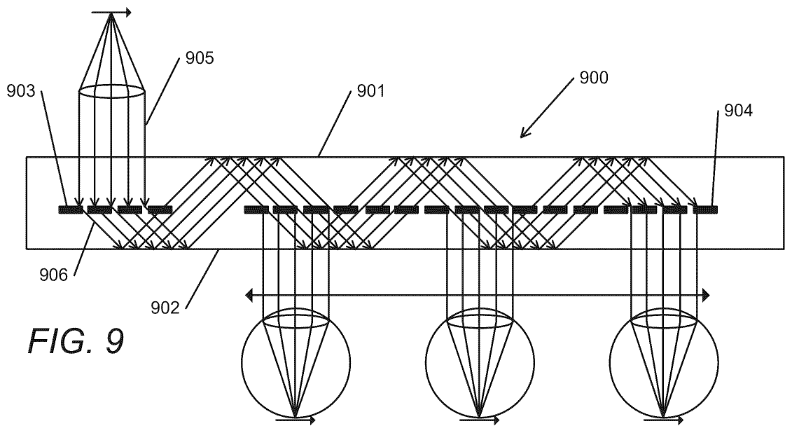

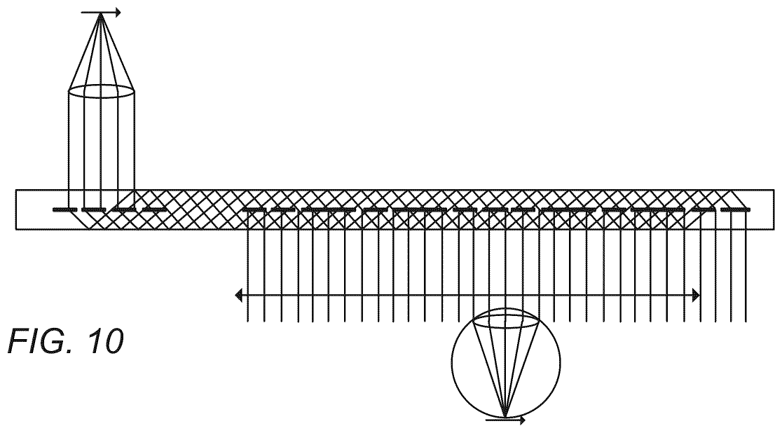

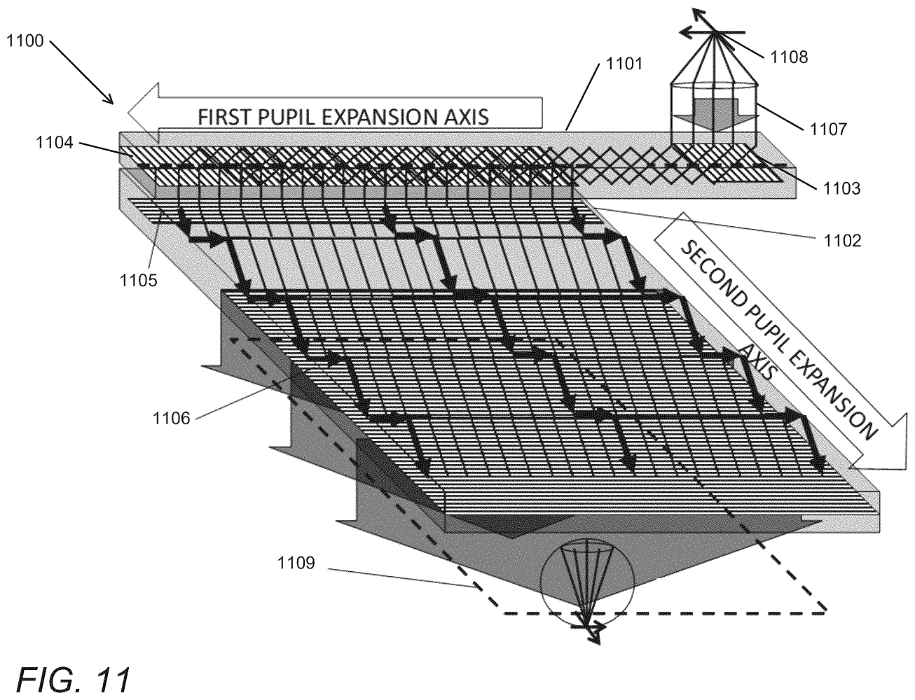

In many embodiments, diffraction gratings can be used to preserve eye box size while reducing lens size by effectively expanding the exit pupil of a collimating optical system. The exit pupil can be defined as a virtual aperture where only the light rays which pass though this virtual aperture can enter a user's eyes. FIGS. 9 and 10 conceptually illustrate waveguides utilizing an output grating for exit pupil expansion in one dimension in accordance with an embodiment of the invention. The waveguide 900 in FIG. 9 includes a first surface 901, a second surface 902, an input grating element 903, and an output grating element 904. As shown, light 905 is coupled into the waveguide 900 by the input grating 902 and can travel through the waveguide 900 via total internal reflection. In the illustrative embodiment, the output grating 904 is extended and designed to refract a portion of the waveguided light. The light can be refracted such that the refracted light 906 is incident on the second surface 902 at an angle at which total internal reflection does not occur, allowing the light 906 to couple out of the waveguide 900. This lossy extraction permits exit pupil expansion as the remaining light can continue to travel within the waveguide 900 and, once the light is again incident on the output grating 904, the scenario described above can occur again. Utilizing this technique, a continuous expanded exit pupil can also be achieved with the correct design, as shown in FIG. 10.

Expanding upon the ideas in FIGS. 9 and 10, an optical waveguide can be designed to expand the exit pupil in two dimensions. In many embodiments, two waveguides can be stacked together to create a system where light coupled into the waveguide stack can achieve exit pupil expansion in two dimensions. FIG. 11 conceptually illustrates a waveguide system utilizing two planar waveguides to provide exit pupil expansion in two dimensions in accordance with an embodiment of the invention. As shown, the system 1100 includes a first waveguide 1101 and a second waveguide 1102. The first waveguide 1101 can include a first input coupling grating 1103 and a first output coupling grating 1104, and the second waveguide 1102 can include a second input coupling grating 1105 and a second output coupling grating 1106. The first input coupling grating 1103 can be designed to couple collimated light 1107 from an image source 1108 into the first waveguide 1101. Similar to the systems as described in FIGS. 9 and 10, the confined light can travel through the first waveguide 1101 via total internal reflection until the light reaches the first output coupling grating 1104. In the illustrative embodiment, the first output coupling grating 1104 is designed to provide lossy exit pupil expansion in a first dimension and to couple the light out of the first waveguide 1101. The second input coupling grating 1105 can be designed to receive light outputted from the first waveguide 1101, which is expanded in the first dimension, and refract the received light such that the received light travels through the second waveguide 1102 via total internal reflection. In many embodiments, the first output coupling grating 1104 and the second input coupling grating 1106 are extended in a similar manner. The light traveling through the second waveguide 1102 can then interact with the second output coupling grating 1106. In the illustrative embodiment, the second output coupling grating 1106 is designed to provide lossy exit pupil expansion in a second dimension that is different from the first dimension and to couple the light out of the second waveguide 1102. As a result, the exit pupil is expanded in two dimensions, allowing for a smaller lens size with respect to the eye box size 1109.

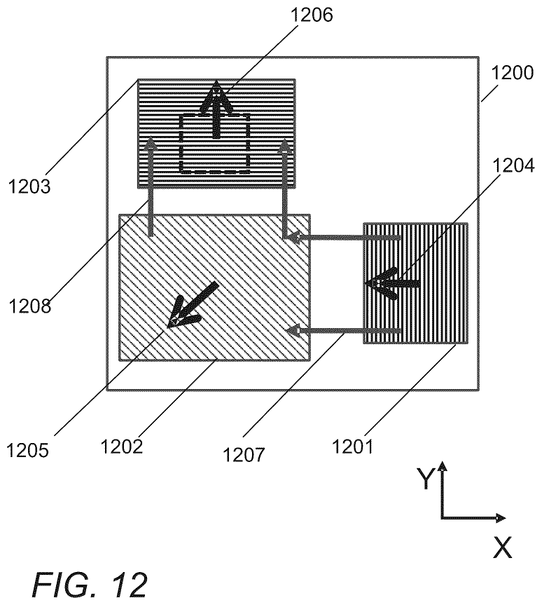

In many embodiments, the optical waveguide utilizes a fold grating, which can provide exit pupil expansion in one dimension while directing the light within the waveguide. In further embodiments, the fold grating directs the light towards an output grating, which can provide exit pupil expansion in a second dimension that is different from the first direction and also couples the light out of the waveguide. By using the fold grating, the waveguide display can require fewer layers than other systems and methods of displaying information. In addition, by using fold grating, light can travel by total internal refection within the waveguide in a single rectangular prism defined by the waveguide outer surfaces while achieving dual pupil expansion. As a result, a two-dimension exit pupil expansion can be achieved using a single waveguide. FIG. 12 conceptually illustrates a waveguide utilizing a three-grating structure to provide two dimensional exit pupil expansion in accordance with an embodiment of the invention. As shown, the waveguide 1200 includes an input grating 1201, a fold grating 1202, and an output grating 1203. Arrows 1204-1206 on the gratings 1201-1203 show the k-vector associated with each grating. In many embodiments, the fold grating 1202 can be designed to provide exit pupil expansion in one dimension and to redirect the direction of light propagating via total internal reflection from the input grating 1201. In the illustrative embodiment, the fringes of the fold gratings 1202 are at a 45 degree offset from either of the other two gratings 1201, 1203. Light incident on the fold grating is redirected 1207, 1208 to propagate towards the output grating 1203, which provides exit pupil expansion in a second dimension and couples the light out of the waveguide 1200.

Although the discussions above relating to FIGS. 8-12 describe specific waveguide structures, it is readily appreciated that any number of waveguide structure configurations can be utilized in accordance with specific requirements of a given application. For example, gratings providing exit pupil expansion can be designed with a gradient efficiency such that the portion of light refracted changes depending on the area of incident.

### Waveguide Layer Stacks

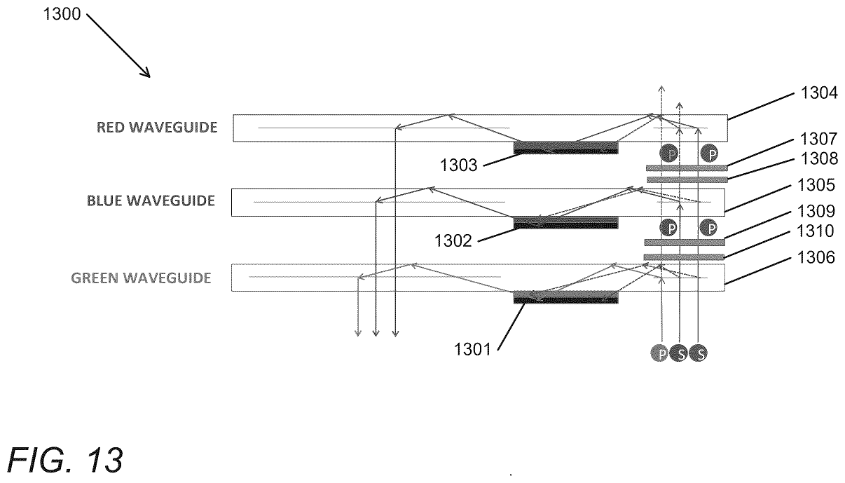

Waveguides in accordance with various embodiments of the invention can be stacked together to implement certain optical functions. For example, in many embodiments, the device can include a stack of RGB diffracting layers, each layer comprising input and output gratings. In each layer the SBGs are recorded to provide peak diffraction efficiency vs. wavelength characteristics (along the waveguide) shifted by small increments from the peak wavelength. In some embodiments, RGB SBG layers are used and can be switched sequentially and synchronously with RGB LEDs image sources. FIG. 13 conceptually illustrates a profile view of an RGB stack of waveguides 1300 in accordance with an embodiment of the invention. In the illustrative embodiment, wavelength selective absorptive layers 1301-1303 are used to selectively absorb unwanted light in each waveguide layer 1304-1306. Dashed lines represent weak coupling due to either off-polarization or off Bragg. The stack of waveguides further includes various filters and waveplates 1307-1311. Polarization orientations are depicted with respect to the input grating.

Although FIG. 13 illustrates a specific structure of a waveguide stack, any of a number of stacking configuration can be used in accordance with specific requirements of a given application. For example, in many embodiments, only two layers, red and blue/green, are used to implement an RGB stack. Such a system can be achieved using several methods. In some embodiments, multiplexed gratings containing different sets of gratings, each correlating with an RGB color, are used to implement multiple color waveguides in one waveguide layer.

### Waveguide Displays

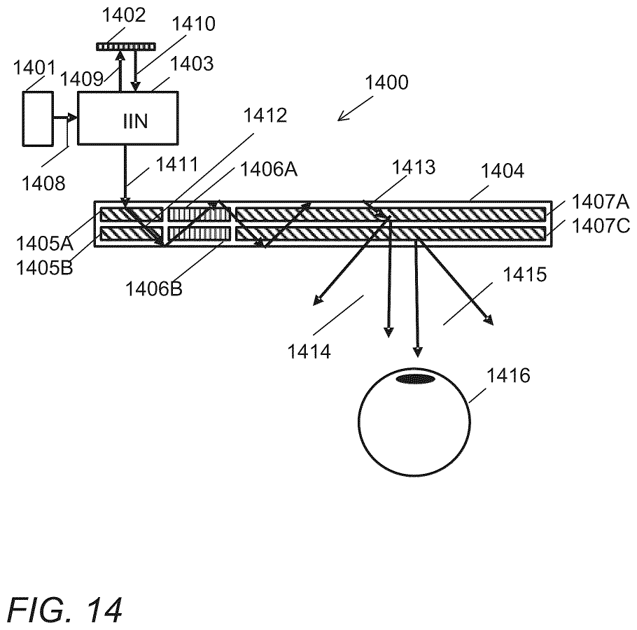

Waveguide displays in accordance with various embodiments of the invention can be implemented and constricted in many different ways. For example, waveguide displays can contain a varying number of waveguide layers and different exit pupil expansion scheme. FIG. 14 conceptually illustrates a dual axis expansion waveguide display with two grating layers in accordance with an embodiment of the invention. As shown, the waveguide display 1400 includes a light source 1401, a microdisplay panel 1402, and an input image node (“IIN”) 1403 optically coupled to a waveguide 1404 having two grating layers. In some embodiments, the waveguide is formed by sandwiched the grating layers between glass or plastic substrates to form a stack within which total internal reflection occurs at the outer substrate and air interfaces. In several embodiments, the stack can further comprise additional layers such as beam splitting coatings and environmental protection layers. In the illustrative embodiment, each grating layer contains an input grating 1405A,1405B, a fold grating exit pupil expander 1406A, 1406B, and an output grating 1407A, 1407B where characters A and B refer to the first and second waveguide layers. The input grating, fold grating, and the output grating can be holographic gratings, such as a switchable or non-switchable SBG. As used herein, the term grating may encompass a grating can include a set of gratings, such as multiplexed gratings or sets of discrete rolled K-vector gratings. In the illustrative embodiment, the IIN 1403 integrates the microdisplay panel 1402, the light source 1401, and optical components needed to illuminate the display panel, separate the reflected light, and collimate it into the required FOV. In the embodiment of FIG. 14 and in the embodiments to be described below, at least one of the input, fold, and output gratings can be electrically switchable. In many embodiments, all three grating types are passive (i.e., non-switching). In a number of embodiments, the IIN can project the image displayed on the microdisplay panel such that each display pixel is converted into a unique angular direction within the substrate waveguide. The collimation optics contained in the IIN can include lens and mirrors. In further embodiments, the lens and mirrors are diffractive lenses and mirrors.

In the illustrative embodiment, the light path from the source to the waveguide via the IIN is indicated by rays 1408-1411. The input grating 1405A, 1405B of each grating layer can couple a portion of the light into a TIR path in the waveguide 1404, such path being represented by the rays 1412, 1413. The output gratings 1407A, 1407B can diffract light out of the waveguide into angular ranges of collimated light 1414, 1415 respectively for viewing by the eye 1416. The angular ranges, which correspond to the field of view of the display, can be defined by the IIN optics. In some embodiments, the waveguide gratings can encode optical power for adjusting the collimation of the output. In several embodiments, the output image is at infinity. In other embodiments, the output image may be formed at distances of several meters from the eye box. Typically, the eye is positioned within the exit pupil or eye box of the display.

Different IIN implementations and embodiments can be utilized as discussed and taught in U.S. patent application Ser. No. 13/869,866, entitled Holographic Wide Angle Display, and U.S. patent application Ser. No. 13/844,456, entitled Transparent Waveguide Display, the disclosures of which are hereby incorporated by reference in their entireties. In some embodiments, the IIN contains a beamsplitter for directing light onto a microdisplay and transmitting the reflected light towards the waveguide. In many embodiments, the beamsplitter is a grating recorded in HPDLC and uses the intrinsic polarization selectivity of such gratings to separate the light illuminating the display and the image modulated light reflected off the display. In several embodiments, the beam splitter is a polarizing beam splitter cube. In a number of embodiments, the IIN incorporates a despeckler. Despecklers are discussed in U.S. Pat. No. 8,565,560, entitled Laser Illumination Device, the disclosure of which is hereby incorporated by reference in its entirety.

The light source can be a laser or LED and can include one or more lenses for modifying the illumination beam angular characteristics. The image source can be a micro-display or laser based display. LED can provide better uniformity than laser. If laser illumination is used, there is a risk of illumination banding occurring at the waveguide output. In many embodiments, laser illumination banding in waveguides can be overcome using the techniques and teachings disclosed in U.S. patent application Ser. No. 15/512,500, entitled Method and Apparatus for Generating Input Images for Holographic Waveguide Displays, the disclosure of which is hereby incorporated by reference in its entirety. In some embodiments, the light from the light source is polarized. In several embodiments, the image source is a liquid crystal display (LCD) micro display or liquid crystal on silicon (LCoS) micro display.

In some embodiments, similar to the one shown in FIG. 14, each grating layer addresses half the total field of view. Typically, the fold gratings are clocked (i.e., tilted in the waveguide plane) at 45 degrees to ensure adequate angular bandwidth for the folded light. In other embodiments, other clock angles can be used to satisfy spatial constraints on the positioning of the gratings that can arise in the ergonomic design of the display. In some embodiments, at least one of the input and output gratings have rolled k-vectors. Rolling the K-vectors can allow the angular bandwidth of the grating to be expanded without the need to increase the waveguide thickness.

In many embodiments, the fold grating's angular bandwidth can be enhanced by designing the grating prescription to provide dual interaction of the guided light with the grating. Exemplary embodiments of dual interaction fold gratings are disclosed in U.S. patent application Ser. No. 14/620,969, entitled Waveguide Grating Device, the disclosure of which is hereby incorporated in its entirety.

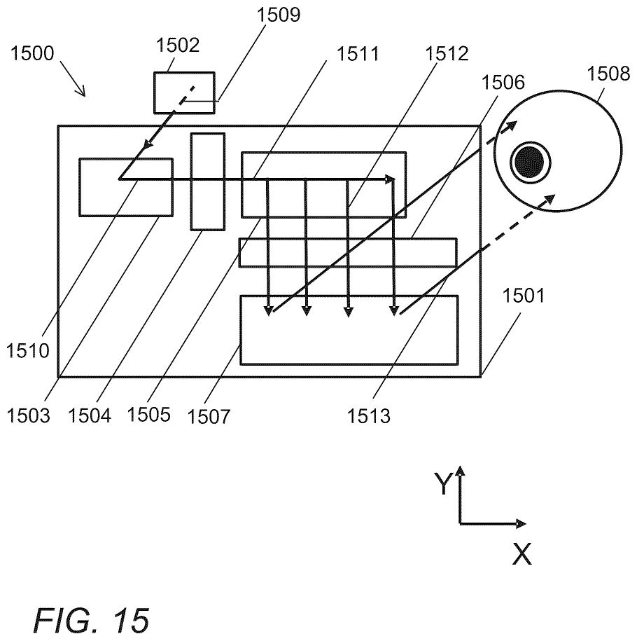

FIG. 15 conceptually illustrates a plan view 1500 of a single grating layer similar to the ones used in FIG. 14 in accordance with an embodiment of the invention. The grating layer 1501, which is optically coupled to the IIN 1502, includes input grating 1503, a first beamsplitter 1504, a fold grating 1505, a second beamsplitter 1506, and an output grating 1507. The beamsplitters can be partially transmitting coatings which homogenize the waveguided light by providing multiple reflection paths within the waveguide. Each beamsplitter can include more than one coating layer with each coating layer being applied to a transparent substrate. Typical beam paths from the IIN up to the eye 1508 are indicated by the rays 1509-1513.

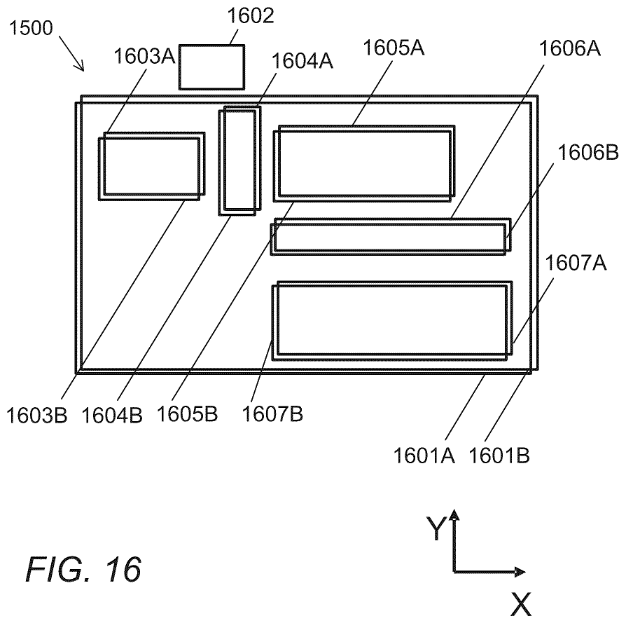

FIG. 16 conceptually illustrates a plan view 1600 of a two grating layer configuration in accordance with an embodiment of the invention. As shown, the grating layers 1601A, 1601B, which are optically coupled to the IIN 1602, includes input gratings 1603A, 1603B, first beamsplitters 1604A, 1604B, fold gratings 1605A, 1605B, second beamsplitters 1606A, 1606B and output gratings 1607A, 1607B, where the characters A, B refer to the first and second grating layers, respectively. In the illustrated embodiment, the gratings and beams splitters of the two layers substantially overlap.

In many embodiments, the grating layer can be broken up into separate layers. For example, in some embodiments, a first layer includes the fold grating while a second layer includes the output grating. In further embodiments, a third layer can include the input grating. In such embodiments, the number of layers can then be laminated together into a single waveguide substrate. In several embodiments, the grating layer includes a number of pieces, including the input coupler, the fold grating, and the output grating (or portions thereof) that are laminated together to form a single substrate waveguide. The pieces can be separated by optical glue or other transparent material of refractive index matching or substantially similar that of the pieces.

In many embodiments, the grating layer can be formed via a cell making process by creating cells of the desired grating thickness and vacuum filling each cell with SBG material for each of the input coupler, the fold grating, and the output grating. In some embodiments, the cell can be formed by positioning multiple plates of glass with gaps between the plates of glass that define the desired grating thickness for the input coupler, the fold grating, and the output grating. In several embodiments, one cell can be made with multiple apertures such that the separate apertures are filled with different pockets of SBG material. Any intervening spaces can then be separated by a separating material (e.g., glue, oil, etc.) to define separate areas. In a number of embodiments, the SBG material can be spin-coated onto a substrate and then covered by a second substrate after curing of the material.

In many embodiments, the input coupler, the fold grating, and the output grating can be created by interfering two waves of light at an angle within the substrate to create a holographic wave front, thereby creating light and dark fringes that are set in the waveguide substrate at a desired angle. Additional, such optical elements can also be fabricated using any of the various methods described in the above sections.

In one embodiment, the input coupler, the fold grating, and the output grating embodied as SBGs can be Bragg gratings recorded in a holographic polymer dispersed liquid crystal (HPDLC) (e.g., a matrix of liquid crystal droplets), although SBGs may also be recorded in other materials. In one embodiment, SBGs are recorded in a uniform modulation material, such as POLICRYPS or POLIPHEM having a matrix of solid liquid crystals dispersed in a liquid polymer. The SBGs can be switching or non-switching in nature. In its non-switching form a SBG has the advantage over conventional holographic photopolymer materials of being capable of providing high refractive index modulation due to its liquid crystal component. Exemplary uniform modulation liquid crystal-polymer material systems are disclosed in United State Patent Application Publication No.: US2007/0019152 by Caputo et al and PCT Application No.: PCT/EP2005/006950 by Stumpe et al. both of which are incorporated herein by reference in their entireties. Uniform modulation gratings are characterized by high refractive index modulation (and hence high diffraction efficiency) and low scatter.

In many embodiments, the input coupler, the fold grating, and the output grating is made of a reverse mode HPDLC material. Reverse mode HPDLC differs from conventional HPDLC in that the grating is passive when no electric field is applied and becomes diffractive in the presence of an electric field. The reverse mode HPDLC may be based on any of the recipes and processes disclosed in PCT Application No. PCT/GB2012/000680, entitled Improvements to Holographic Polymer Dispersed Liquid Crystal Materials and Devices, the disclosure of which is hereby incorporated in its entirety. The grating can be recorded in any of the above material systems but used in a passive (non-switching) mode. The fabrication process is identical to that used for switched but with the electrode coating stage being omitted. LC polymer material systems are highly desirable in view of their high index modulation. In some embodiments, the gratings are recorded in HPDLC but are not switched.

In many embodiments, the input grating can be replaced by another type of input coupler, such as but not limited to a prism and a reflective surface. In some embodiments, the input coupler can be a holographic grating, such as an SBG grating or a passive grating, which can be a passive SBG grating. The input coupler can be configured to receive collimated light from a display source and to cause the light to travel within the waveguide via total internal reflection between the first surface and the second surface to the fold grating. The input coupler can be orientated directly towards or at an angle relative to the fold grating. For example, in several embodiments, the input coupler can be set at a slight incline in relation to the fold grating. In a number of embodiments, the fold grating can be oriented in a diagonal direction. The fold grating can be configured to provide pupil expansion in a first direction and to direct the light to the output grating via total internal reflection inside the waveguide.

In many embodiments, a longitudinal edge of each fold grating is oblique to the axis of alignment of the input coupler such that each fold grating is set on a diagonal with respect to the direction of propagation of the display light. The fold grating can be angled such that light from the input coupler is redirected to the output grating. In some embodiments, the fold grating is set at a forty-five-degree angle relative to the direction that the display image is released from the input coupler. This feature can cause the display image propagating down the fold grating to be turned into the output grating. For example, in several embodiments, the fold grating can cause the image to be turned 90 degrees into the output grating. In this manner, a single waveguide can provide dual axis pupil expansion in both the horizontal and vertical directions. In a number of embodiments, each of the fold grating can have a partially diffractive structure. In some embodiments, each of the fold gratings can have a fully diffractive structure.

The output grating can be configured to provide pupil expansion in a second direction different than the first direction and to cause the light to exit the waveguide from the first surface or the second surface. The output grating can receive the display image from the fold grating via total internal reflection and can provide pupil expansion in a second direction. In many embodiments, the output grating includes multiple layers of substrate, thereby comprising multiple layers of output gratings. Accordingly, there is no requirement for gratings to be in one plane within the waveguide, and gratings may be stacked on top of each other (e.g., cells of gratings stacked on top of each other).

In many embodiments, a quarter wave plate on the substrate waveguide rotates polarization of a light ray to maintain efficient coupling with the SBGs. The quarter wave plate can be coupled to or adhered to the surface of substrate waveguide. For example, in some embodiments, the quarter wave plate is a coating that is applied to substrate waveguide. The quarter wave plate can provide light wave polarization management. Such polarization management can help light rays retain alignment with the intended viewing axis by compensating for skew waves in the waveguide. The quarter wave plate is optional and can increase the efficiency of the optical design in implementations. In several embodiments, the waveguide does not include the quarter wave plate. The quarter wave plate may be provided as multi-layer coating.

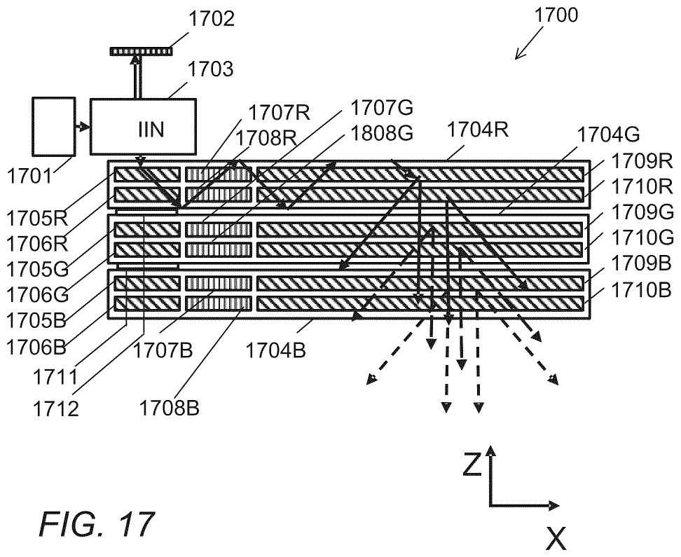

In many embodiments, the waveguide display can be operated in monochrome. In some embodiments, the waveguide display can be operated in color. Operating in color can be achieved using a stack of monochrome waveguides of similar design to the one in FIG. 14. The design can use red, green, and blue waveguide layers as shown or, alternatively, red and blue/green layers. FIG. 17 conceptually illustrates a dual axis expansion waveguide display 1700 that includes a light source 1701, a microdisplay panel 1702, and an IIN 1703 optically coupled to red, green, and blue waveguides 1704R, 1704G, 1704B, with each waveguide including two grating layers in accordance with an embodiment of the invention. In the illustrative embodiment, the three waveguides are separated by air gaps. In some embodiments, the waveguides are separated by a low index material such as a nanoporous film. As shown, the red grating layer labelled by R includes an input grating 1705R, 1706R, a fold grating exit pupil expander 1707R, 1708R, and an output grating 1709R, 1710R. The grating elements of the blue and green waveguides are labeled using the same numerals with B, G designating blue and green. In some embodiments, the input, fold, and output gratings are all passive, that is non-switching. In several embodiments, at least one of the gratings is switching. In a number of embodiments, the input gratings in each layer are switchable to avoid color crosstalk between the waveguide layers. In many embodiments, color crosstalk can be avoided by disposing dichroic filters 1711, 1712 between the input grating regions of the red and blue and the blue and green waveguides. In a variety of embodiments, a color waveguide can be implemented using just one grating layer in each monochromatic waveguide

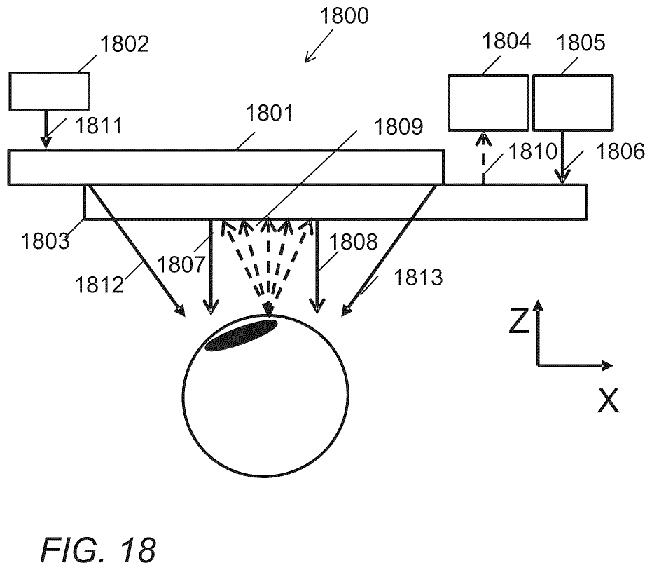

FIG. 18 conceptually illustrates an eye tracker display in accordance with an embodiment of the invention. Waveguide device based eye trackers are discussed in PCT Application No. PCT/GB2014/000197, entitled Holographic Waveguide Eye Tracker, PCT Application No. PCT/GB2015/000274, entitled Holographic Waveguide Optical Tracker, and PCT Application No. PCT/GB2013/000210, entitled Apparatus for Eye Tracking, the disclosures of which are hereby incorporated in their entireties. Turning again to FIG. 18, the eye tracked display 1800 includes a dual axis expansion waveguide display based on any of the embodiments described above. The waveguide display can include a waveguide 1801 containing at least one grating layer incorporating an input fold and output grating, the IIN 1802, an eye tracker including waveguide 1803, infrared detector 1804, and infrared source 1805. The eye tracker and display waveguides can be separated by an air gap or by a low refractive material. As explained in the above references, the eye tracker can comprise separate illumination and detector waveguides. In the illustrative embodiment, the optical path from the infrared source to the eye is indicated by the rays 1806-1808, and the backscattered signal from the eye is indicated by the rays 1809, 1810. The optical path from the input image node through the display waveguide to the eye box is indicated by the rays 1811-1813.

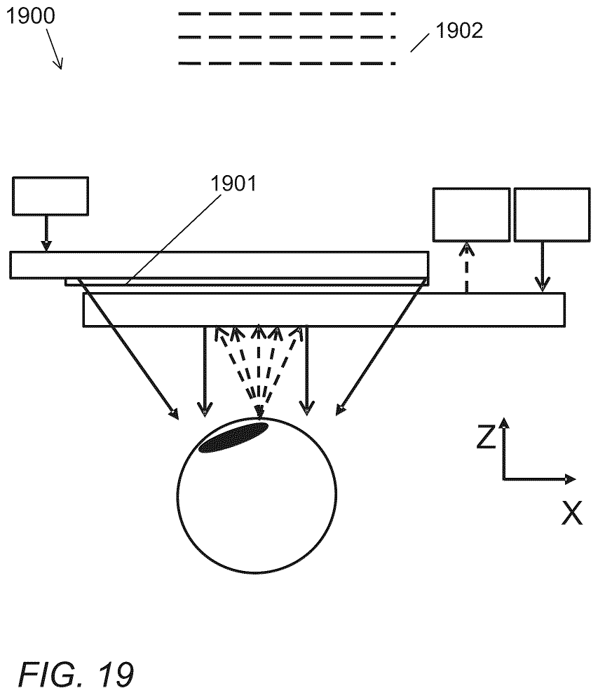

In many embodiments, a dual expansion waveguide display can further include a dynamic focusing element. FIG. 19 conceptually illustrates a dual expansion waveguide display 1900 with a dynamic focusing element 1901 disposed in proximity to a principal surface of the waveguide display and an eye tracker in accordance with an embodiment of the invention. In some embodiments, the dynamic focusing element is an LC device. In several embodiments, the LC device combines an LC layer and a diffractive optical element. In a number of embodiments, the diffractive optical element is an electrically controllable LC-based device. In various embodiments, the dynamic focusing element is disposed between the waveguide display and the eye tracker. In a variety of embodiments, the dynamic focusing element can be disposed in proximity to the surface of the display waveguide furthest from the eye.

The dynamic focus device can provide a multiplicity of image surfaces 1902. In light field display applications, at least four image surfaces can be used. The dynamic focusing element can be based on dynamic focusing elements described in U.S. patent application Ser. No. 15/553,120 entitled, Electrically Focus Tunable Lens, the disclosure of which is hereby incorporated in its entirety. In some embodiments, a dual expansion waveguide display having a dynamic focusing element and an eye tracker can provide a light field display, such as those based on the teachings disclosed in U.S. patent application Ser. No. 15/543,013, entitled Holographic Waveguide Light Field Displays, the disclosure of which is hereby incorporated by reference in its entirety.

Although specific waveguide structures are discussed above, any of a number of waveguide structures can be implemented depending on the specific requirements of a given application. For example, in many waveguide configurations, the input, fold, and output gratings are formed in a single layer sandwiched by transparent substrates. Such a configuration is shown in FIG. 14, where two layers are stacked as such. In some embodiments, the waveguide includes just one grating layer. In several embodiments, switching transparent electrodes are applied to opposing surfaces of the substrate layers sandwiching the switching grating. In a number of embodiments, the cell substrates can be fabricated from glass. One glass substrate that can be used is standard Corning Willow glass substrate (index 1.51) which is available in thicknesses down to 50 micrometers. In other embodiments, the cell substrates can be optical plastics.

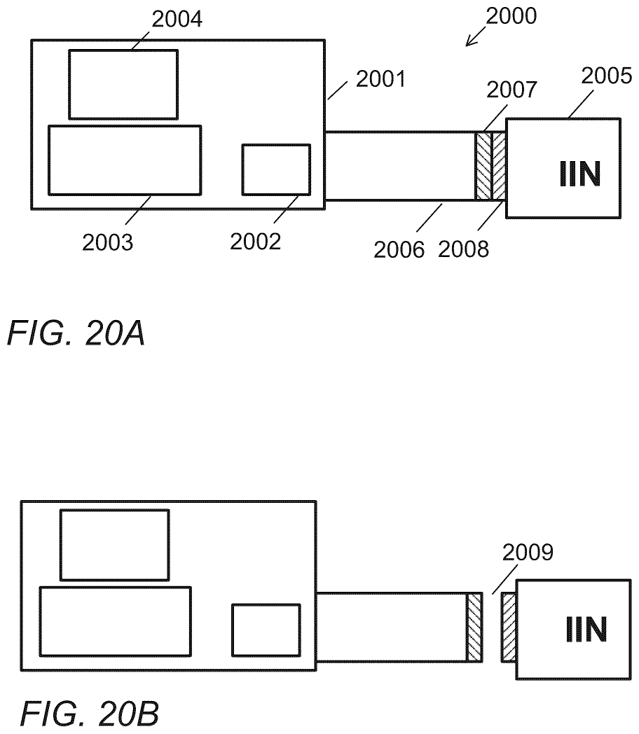

In many embodiments, the waveguide display is coupled to the IIN by an opto-mechanical interface that allows the waveguide to be easily retracted from the IIN assembly. The basic principle is conceptually illustrated in FIG. 20A. FIG. 20A shows a dual axis expansion waveguide display 2000 including a waveguide 2001 containing an input grating 2002, a fold grating 2003, an output grating 2004, and an IIN 2005. The apparatus further includes an optical link 2006 connected to the waveguide, a first optical interface 2007 terminating the optical link, and a second optical interface 2008 forming the exit optical port of the IIN. The first and second optical interfaces can be decoupled as indicated by gap 2009 shown in FIG. 20B. In some embodiments, the optical link is a waveguide. In several embodiments, the optical link is curved. In a number of embodiments, the optical link is a GRIN image relay device. In a variety of embodiments, the optical connection is established using a mechanical mechanism. In some embodiments, the optical connection is established using a magnetic mechanism. The advantage of decoupling the waveguide from the IIN in helmet mounted display applications is that the near eye portion of the display can be removed when not in used. In some embodiments where the waveguide includes passive gratings, the near eye optics can be disposable.

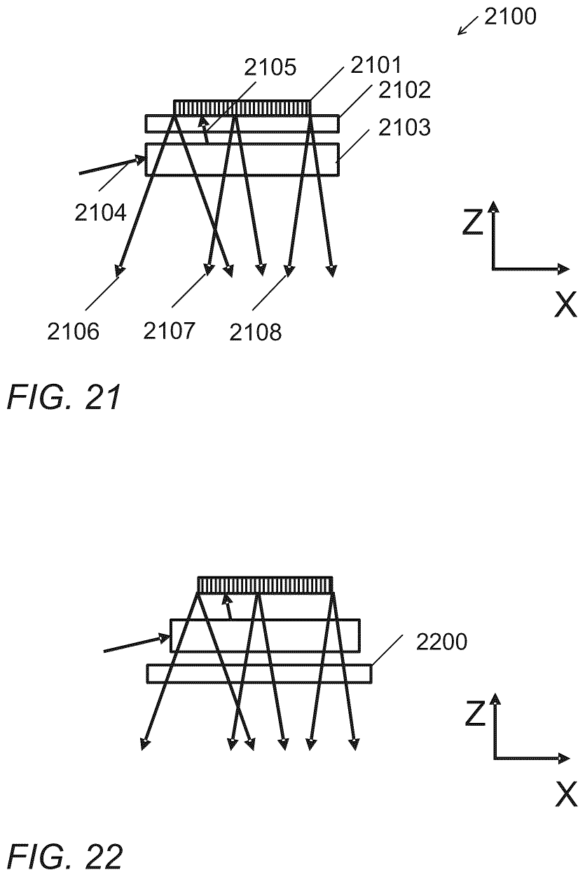

FIG. 21 conceptually illustrates an IIN 2100 having a microdisplay panel 2101, a spatially-varying NA component 2102, and microdisplay optics 2103 in accordance with an embodiment of the invention. As shown, the microdisplay optics 2103 accepts light 2104 from an illumination source (not illustrated) and deflects the light onto the microdisplay in the direction indicated by ray 2105. The light reflected from the microdisplay is indicated by the divergent ray pairs 2106-2108 with numerical aperture (“NA”) angles varying along the X axis. In the illustrative embodiment, the spatially-varying NA component is disposed between the microdisplay optics and the microdisplay. In other embodiments, the spatially-varying NA component is disposed adjacent the output surface of the microdisplay optics. FIG. 22 conceptually illustrates such an embodiment, shown by spatially-varying NA component 2200.

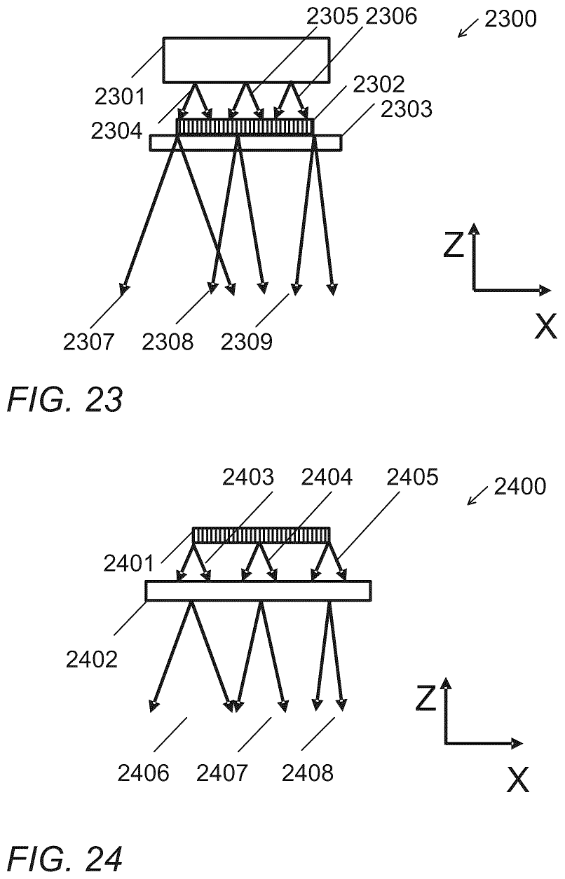

In many embodiments, the microdisplay is a reflective device. In some embodiments, the microdisplay is a transmission device, typically a transmission LCoS device. FIG. 23 conceptually illustrates an IIN 2300 including a backlight 2301, a microdisplay 2302, and a variable NA component 2303 in accordance with an embodiment of the invention. Light from the backlight indicated by the rays 2304-2306, which typically has a uniform NA across the backlight, illuminates the back surface of the microdisplay and, after propagation through the variable NA component, is converted into output image modulated light indicated by the divergent ray pairs 2307-2309 with NA angles varying along the X axis.

In many embodiments, the principles of the invention may be applied to an emissive display. Examples of emissive displays for use with the invention include ones based on LED arrays and light emitting polymers arrays. FIG. 24 conceptually illustrates an IIN 2400 having an emissive microdisplay 2401 and a spatially-varying NA component 2402 in accordance with an embodiment of the invention. Light from the microdisplay indicated by rays 2403-2405, which typically has a uniform NA across the emitting surface of the display, illuminates the spatially-varying NA component and is converted into output image modulated light indicated by divergent ray pairs 2406-2408 with NA angles varying along the X axis.

In many embodiments, the microdisplay optics includes a polarizing beam splitter cube. In some embodiments, the microdisplay optics includes an inclined plate to which a beam splitter coating has been applied. In a number of embodiments, the microdisplay optics includes a waveguide device comprising a SBG, which acts as a polarization selective beam splitter. Details relating to such embodiments are discussed U.S. patent application Ser. No. 13/869,866, entitled Holographic Wide Angle Display, and U.S. patent application Ser. No. 13/844,456, entitled Transparent Waveguide Display, the disclosures of which are hereby incorporated in their entireties. In several embodiments, the microdisplay optics contains at least one of a refractive component and curved reflecting surfaces or a diffractive optical element for controlling the numerical aperture of the illumination light. In some embodiments, the microdisplay optics contains spectral filters for controlling the wavelength characteristics of the illumination light. In a number of embodiments, the microdisplay optics contains apertures, masks, filter, and coatings for controlling stray light. In many embodiments, the microdisplay optics incorporate birdbath optics.

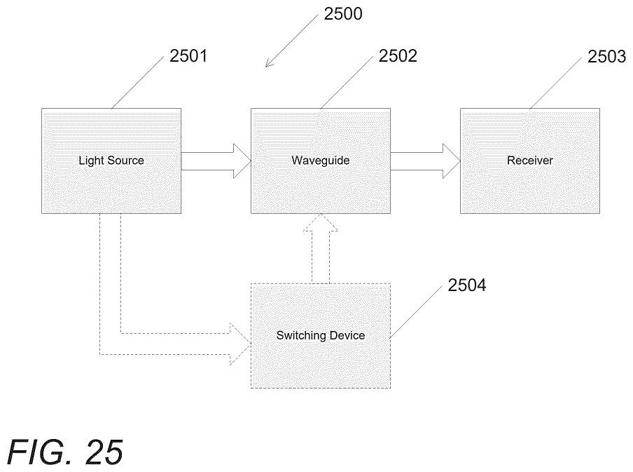

Although FIGS. 14-24 describe specific waveguide displays and structures, any waveguide display system and configuration can be used as appropriate to the specific requirements of a given application. At its core, waveguides are simply used to manipulate the direction of light. This property can be used generally in a variety of different systems. An example of a general system that can utilize waveguides is shown in FIG. 25. FIG. 25 conceptually illustrates a system diagram showing components for waveguide displays in accordance with various embodiments of the invention. As shown, the system 2500 utilizes a light source 2501 that can output light into a waveguide 2502. Light sources used can be a variety of different systems. In some embodiments, the light source 2501 is from a projector. In many embodiments, the light source 2501 further includes a microdisplay panel and optical components needed to illuminate the display panel. In further embodiments, the light source 2501 includes collimators and other optical components for manipulating the light into a desired form before entry into the waveguide. In other embodiments, the light source 2501 is natural light. Once the light source 2501 outputs light into the waveguide 2502, the waveguide 2502 can then manipulate and redirect light in a desired manner out and into a receiver 2503. Waveguides can be any general waveguides known within the art and/or one of the waveguides as described above. A receiver can be any of a number of components capable of receiving light from the waveguide. In many embodiments, the receiver 2503 is a user's eye(s). In some embodiments, the receiver 2503 is another waveguide. In several embodiments, the receiver 2503 is a display capable of displaying the light from the waveguide 2502. In further embodiments, the display is simply glass that can reflect the light onto another receiver. The system 2500 can optionally include a switching device 2504 and electrical components for use in conjunction with SBGs. In many embodiments, the switching device 2504 can optionally receive data from the light source in order to introduce a voltage to turn the SBGs in an ON position at the appropriate times.

### Waveguide Exposure Processes and Mastering Systems

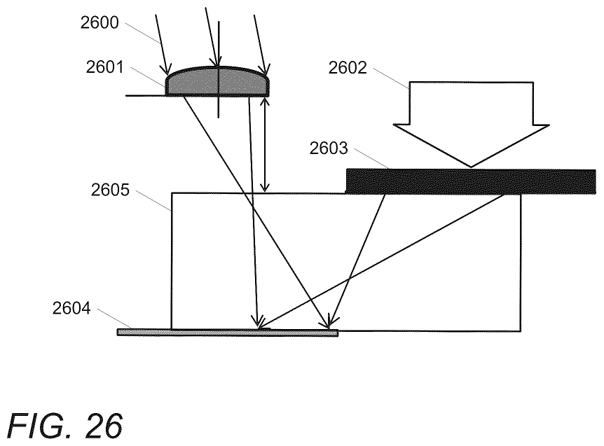

In addition to the exposure schemes described in FIGS. 4A-4D for the recording of both transmission and reflection waveguides, many mastering techniques can be used to perform such recordings and to form various waveguide structures and gratings. In various embodiments, the mastering system includes the use of an amplitude grating (“AG”). Such gratings can be used to form various types of gratings with different configurations. In many embodiments, an amplitude master grating is used to form an RKV grating within a waveguide. In further embodiments, the amplitude grating contains a linear variation in the grating period, called a chirp. Chirped gratings can be utilized in many different ways. FIG. 26 conceptually illustrates an exposure process utilizing a chirped amplitude grating in accordance with an embodiment of the invention. As shown, the process includes the use of an input beam 2600 interacting with a focusing element 2601 to provide 1D focus. A zero order input beam 2602 can be directed towards a chirped AG 2603, providing a diffraction profile with a linear variation. The two beams can then combine to form a desired interference pattern to expose a waveguide substrate 2604. As shown, separation distance from the exposure plane and the origin of the diffracted beam(s) can be crucial. In the illustrative embodiment, a transparent spacer block 2605 is used to control the separation distance.

In many embodiments, a single beam exposure system can be used in conjunction with the amplitude grating to form gratings within a waveguide. FIG. 5 conceptually illustrates one such embodiment. Use of a single beam in a near to contact copy mode can be considered a hybrid between a direct contact copy and a separate two-beam contact copy—i.e., a hybrid contact copy. This approach can be useful where it is not possible to make a direct contact copy, such as where the separation distance from the master plane to the exposure plane is not negligible. In such circumstances, the separation distance can be critical. For example, in the exposure process for an RKV grating, the separation distance can be important and should be accounted for in order to preserve the surface projected fringe period across the full RKV grating (without which full waveguide path reciprocity cannot be maintained). In several embodiments, a single plane wavefront input beam can be configured to interact with a cylindrical lens to provide 1D focus. In further embodiments, at least a portion of the light can generate a diffractive beam through interaction with a chirped master, and another portion can pass through (with attenuation) as zero order, preserving the original 1D focus function of the cylindrical lens.

In many embodiments, a master can be designed to incorporate more than one amplitude grating. By incorporating multiple amplitude gratings in a single master, alignment errors can be reduced compared to systems utilizing a single master for each grating. In some embodiments, the mastering system includes a master with three amplitude gratings. In several embodiments, the master can be developed to incorporate the RKV functionality in the simultaneous exposure of three patterns written in one plate. The input and/or output master gratings can be chirped gratings, with additional gratings as needed in zero order regions where there is no overlap with the chip.

In many embodiments, mastering multiple grating elements within a waveguide structure can involve the use of multiple exposures. In such embodiments, a multi-step process can be used wherein different regions corresponding to different grating elements of the contact copy element are exposed. In many such embodiments, the process can include sequentially exposing the contact copy. For example, the process can include first exposing an output grating region (e.g., using a large area O/P only master or part of a multi-grating master) and then multiple exposures to form the fold grating region.

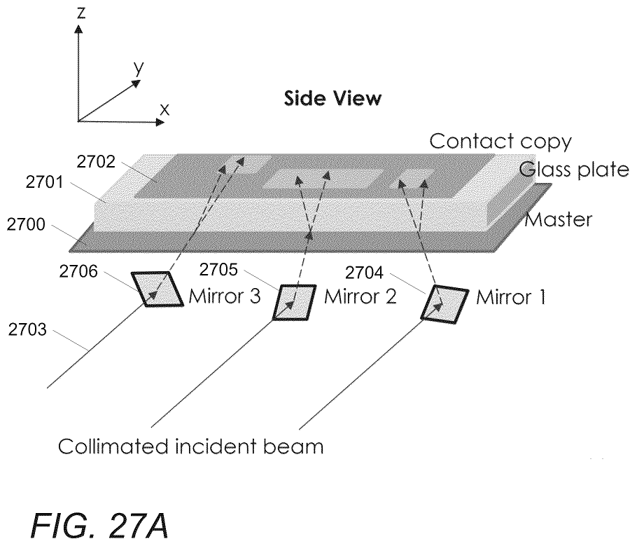

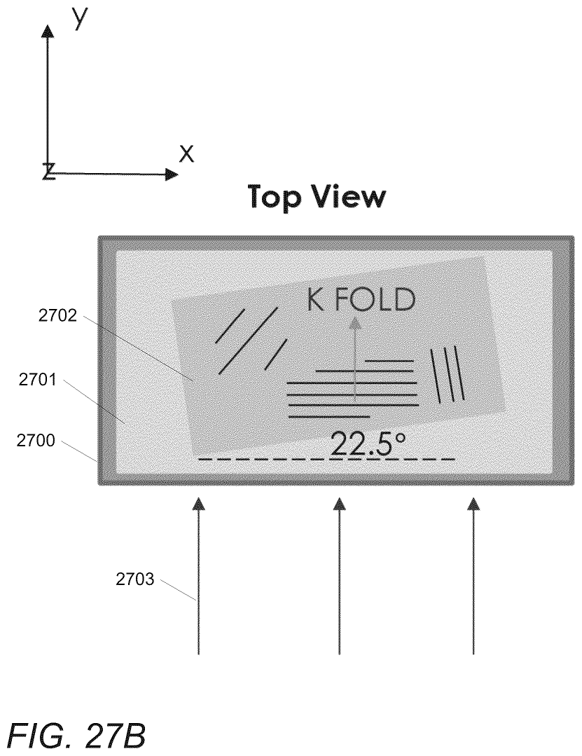

Masters incorporating more than one amplitude grating can also be utilized for the simultaneous exposure of more than one grating. In such systems, a collimated or coherent incident light beam is generally brought into focus via optics through a master AG and onto the desired regions of the contact copy through a suitable transparent substrate material. FIGS. 27A and 27B conceptually illustrate an exposure process for forming three gratings simultaneously in accordance with an embodiment of the invention. As shown, in many such embodiments, optics are used to directed collimated light onto the desired grating regions simultaneously to effect formation of multiple gratings (e.g., input, output and fold) in one exposure. In the illustrative embodiment, the process includes the use of a master 2700 containing grating, a glass plate 2701 for adjusting the separation distance, and a contact copy substrate 2702 as material in which the gratings are recorded. The process utilizes a collimated beam 2703 directed at three mirrors 2704-2706, which redirects the beam 2703 towards the master grating 2700. Once the beam 2703 is incident upon the master grating 2700, an exposure/curing process similar to one described in FIG. 5 can occur, forming three different gratings simultaneously on the contact copy 2702. In many embodiments, a 3:1 mastering process can be utilized to fabricate a holographic waveguide having input, fold and output gratings in a single exposure. In a variety of such embodiments, the input, fold, and/or output gratings are RKV gratings. In a number of embodiments, the fold grating may be segmented into multiple zones. Although any number of zones can be utilized in accordance with the requirements of specific applications, in some embodiments of the invention the fold grating may be divided into 5 segments.

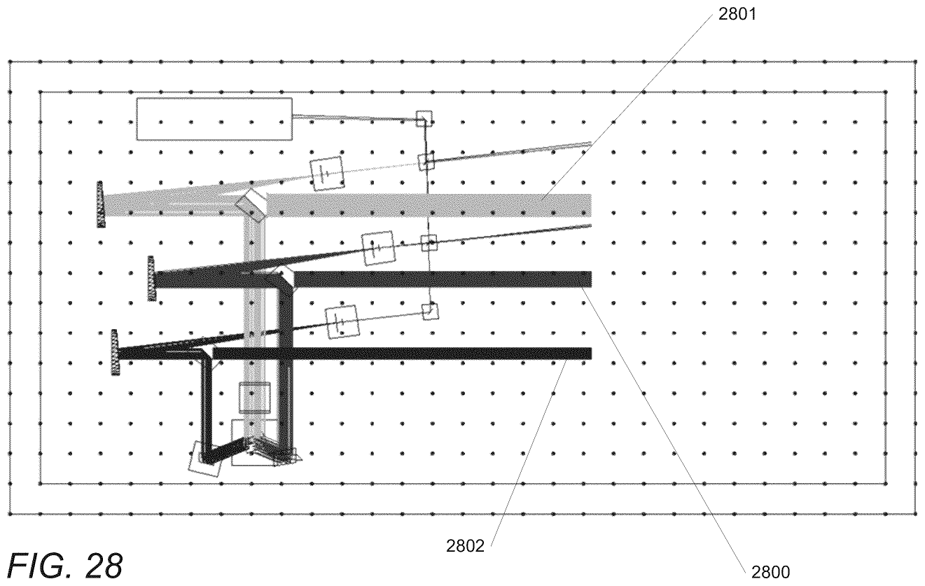

Although FIGS. 27A and 27B show a specific number and arrangement of gratings to be formed, it will be understood that any number and arrangement of such gratings can be provided. Similarly, any number and arrangement of illumination beams can be provided. For example, as shown in FIG. 28, where a three color waveguide is required, beams can be optically arranged to allow for beams for red 2800, green 2801, and blue 2802 channels to be incident through the master onto the contact copy area. Although FIGS. 27A, 27B, and 28 show conceptual drawings of the mastering systems and arrangement, it will be understood that these conceptual elements can take the form of any suitable optical frames, movable adapters, exposure plates, etc. required to allow for the fixation of optical elements relative to the master and contact copy regions.

As previously described, the holographic waveguides implemented in association with the mastering and fabrication embodiments can be a single piece and/or as a stack of waveguides in accordance with the requirements of specific applications of embodiments of the invention. For example, a holographic waveguide can include three layers, one for each of red, blue, and green. A conceptual illustration of a holographic waveguide having three layers is shown and discussed in relation to FIG. 13.

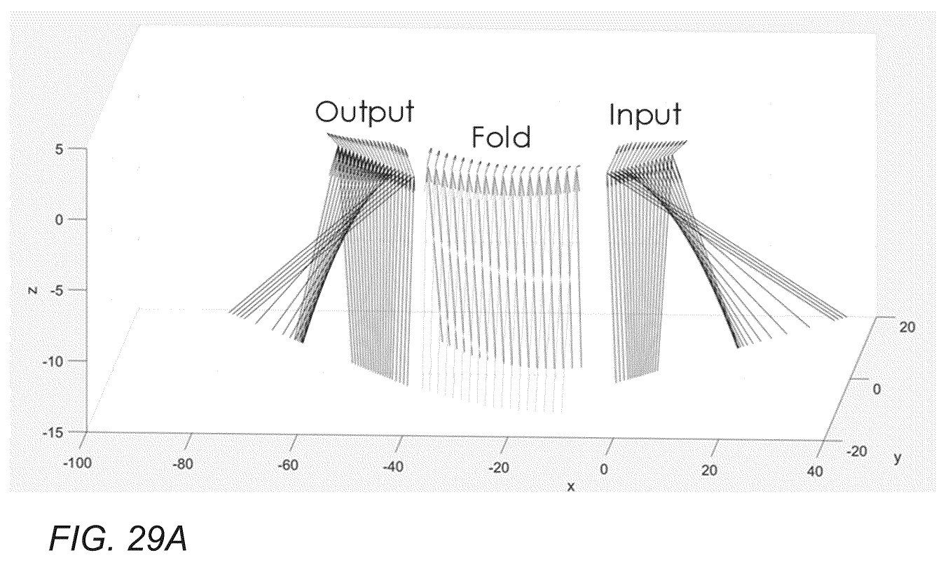

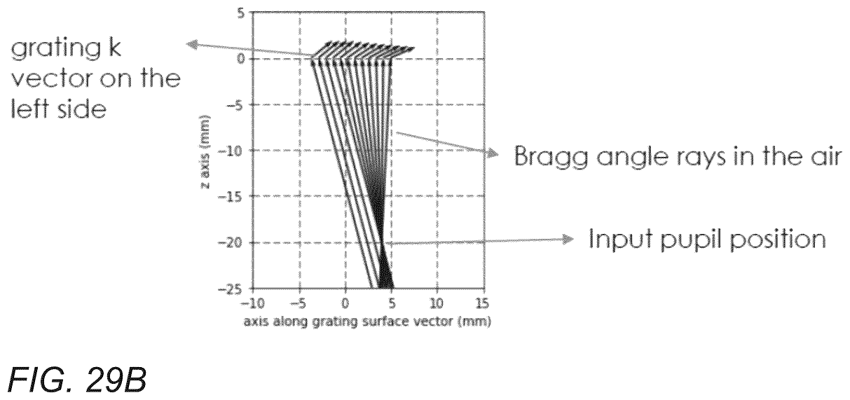

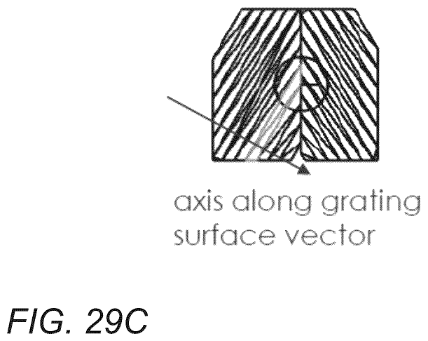

In the typical RKV grating, the grating vector rolls in the same plane as the incident plane of the construction beams. In the fold grating, the grating vector can roll perpendicular to the incident plane of the construction beams. Turning now to FIGS. 29A-29C, conceptual illustrations of a variety of approaches for generating RKV gratings in accordance with a number of embodiments of the invention are shown. Many embodiments include a stepped fold RKV, where the angle in each section changes orthogonally to the K-vector direction, as shown in FIGS. 29B and 29C. Cross term MUX limitations are overcome by the scanned beam, single input angle at any single time approach. Several embodiments include scanned RKV fold gratings, where a scanned beam exposes the RKV with a different angle in discrete steps across the aperture of the plane fold master grating to generate a stepped master. As previously discussed, in a number of embodiments, only a single input beam angle is used to illuminate the fold master at any given time.

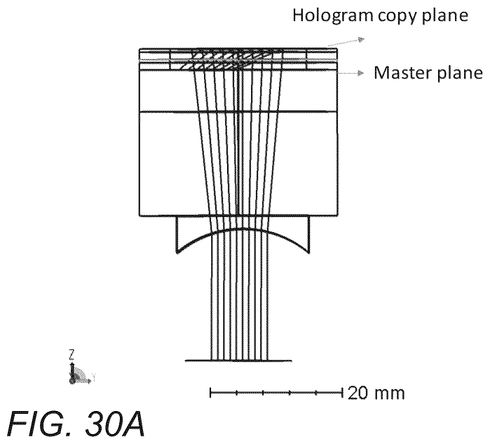

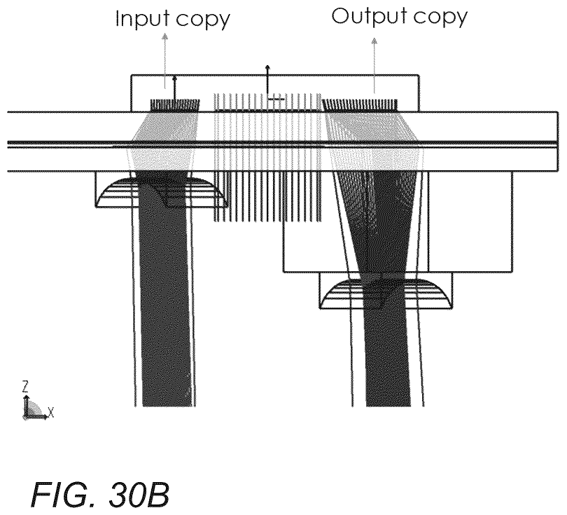

In addition to the discussion above, mastering systems in accordance with many embodiments of the invention can employ chirped gratings for various other purposes, as shown in FIG. 30A. These chirped gratings can aid in correcting when the incident beam on the exposure plane is not collimated and for differences between the master and the holographic waveguide being fabricated. For example, the holographic waveguide is typically inside a waveguide cell of finite thickness while the master typically has a thin protective cover applied to prevent damage to the chrome. Chirped gratings can be utilized to compensate for these additional layers. Any of a variety of protective coatings, such as glass and SiO₂ protective layers, can be utilized as appropriate to the requirements of specific applications of embodiments of the invention.

A conceptual illustration of a dual chirped grating master in accordance with an embodiment of the invention is shown in FIG. 30B. 3:1 dual chirped gratings provide a variety of advantages over prior art manufacturing techniques. RKVs can dramatically improve efficiency and uniformity of the holographic waveguides. RKV inputs can provide more input coupling to the waveguide, and RKV outputs can provide better pupil forming, allowing for improved brightness. As discussed above, allowing exposure of RKV input and output grating (and fold) at the same time can reduce the total manufacturing/process time. In many embodiments, both gratings share the same spacer and/or optical density between master and holographic waveguide, so the RKV profiles and the spacer windows may be configured to be balanced.

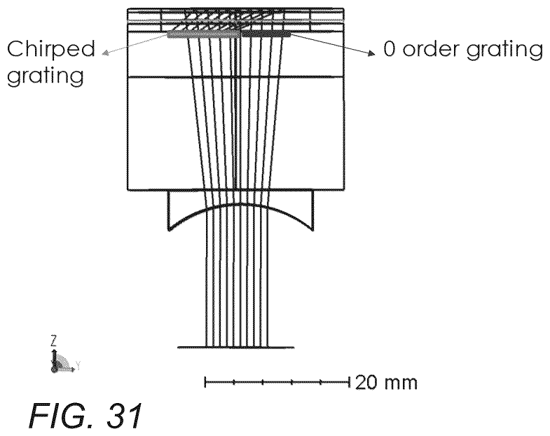

A variety of mastering systems in accordance with embodiments of the invention utilize zero order gratings. Zero order gratings can be used to control the transmittance of the zero order beam, so that it would be close to the transmittance of chirped grating to allow a continuous beam ratio. This prevents a discontinuity on the exposure (and hence diffraction efficiency in the copied grating part). A conceptual illustration of a mastering system utilizing a zero order grating along with a chirped grating in accordance with an embodiment of the invention in shown in FIG. 31. In a variety of embodiments, a zero order grating does not have a diffraction order or the diffraction order does not interfere with the system. The orientation of the master and/or energy beam can be used to control the direction of the unwanted diffracting beam, but then account needs to be taken of the relative polarizations of the grating and the zero order beam. To eliminate the diffraction, in various embodiments, the period of the grating can be smaller than the limit to get evanescent diffraction wave. In a variety of embodiments, using a master grating having a similar transmittance and/or period as the chirp grating at the boundary allows for a seamless copy to be created in the liquid crystal substrate.

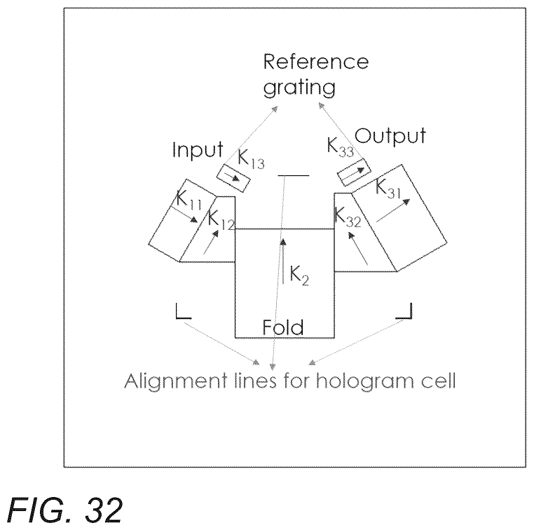

In many embodiments, mastering systems utilize a reference grating to align the lens position to get accurate grating period. A conceptual illustration of such a system is provided in FIG. 32, showing reference gratings K₁₃ (input) and K₃₃ (output) relative to input chirp (K₁₁) and 0 order plane (K₁₂) gratings, output chirp (K₃₂) and 0 order plane gratings (K₃₂), and fold grating (K₂). The reference grating can help improve the 3:1 construction by allowing exposure of input, fold, and output gratings at the same time, which reduces the total manufacture time, providing high accuracy: the accuracy of the grating alignment is given by the master, which can be accurate to 0.1 nm, and a compact design, which make it attractive for larger volume manufacture. In several embodiments, the energy beam is collimated. To ensure that a collimated incident beam for the generation or RKV grating is being used, a reverse ray tracing can be employed by tracing the ideal construction rays from the holographic waveguide to the lens, modifying the window thickness is used to change the focus of the beam relative to the hologram plane, and shifting the lens can achieve collimated beam output from the master to the liquid crystal substrate.

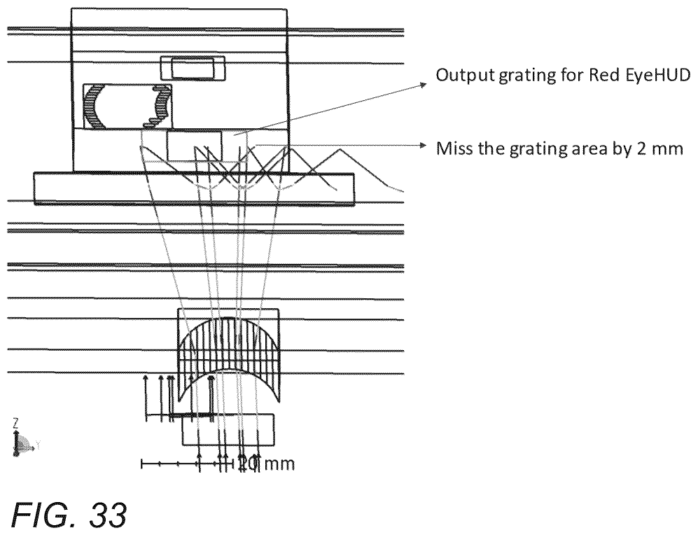

In several embodiments, mastering systems avoid other order beams from being created and/or interfering with the energy beam being focused on the liquid crystal substrate, as shown in FIG. 33. In order to avoid the undesired order beam hitting the grating area, the window thickness can be adjusted, the glass can be modified, the RKV profile can be changed, the lens and/or change the incident beam angle can be changed, and/or a low refractive index material can be used to make the undesired order totally reflected by the low refractive index material.

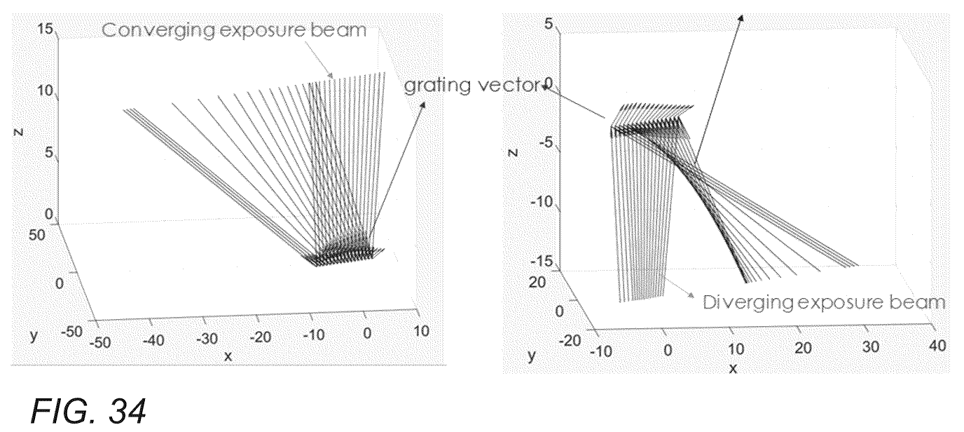

In a number of embodiments, mastering systems utilize one or more diffraction means, where the same position in the master needs to generate two different refracted beams, which is not possible unless they are different diffraction orders. To simplify the fabrication, the master is disposed in a configuration where there is no cross over of diffracted beams. In a variety of embodiments, the master is placed as close as possible to the liquid crystal substrate. In several embodiments, the master is placed far enough where the cross over ends, but this can induce large separation between the 0 order and the diffracted beam. When the master is placed too far away, crossover of the diffracted beam can occur (see, e.g., FIG. 34). When the master is placed too close, undesired diffracted orders can hit the liquid crystal substrate. Therefore, mastering systems in accordance with embodiments of the invention limit the distance from the liquid crystal substrate to master plate is to a range. To increase this range, high index glass can be used to reduce the ray angle so that it takes longer travel for the diffracted beam to cross over. Additionally, short wavelength exposure can also reduce the ray angle, which helps as well. In many embodiments where high index plates are used in the master stack, Fresnel reflections need to be managed; particularly for high index plates between the master and the copy plane.

### Doctrine of Equivalents

Although specific systems and methods are discussed above, many different embodiments can be implemented in accordance with the invention. It is therefore to be understood that the present invention can be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents. Although specific embodiments have been described in detail in this disclosure, many modifications are possible (for example, variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

What is claimed is:

1. A method for recording holograms, the method comprising:
providing a waveguide cell comprising a layer of polymer dispersed liquid crystal mixture sandwiched between two substrates;
providing a master grating;
emitting at least one recording beam toward the master grating;
scanning the at least one recording beam in discrete steps and in at least one different angle, across an aperture of the master grating;
wherein upon interaction with the master grating, a portion of the at least one recording beam is diffracted towards the waveguide cell; and
recording at least one volume grating within the waveguide cell using interferential exposure formed from at least the diffracted portion of the at least one recording beam.

2. The method of claim 1, wherein the master grating comprises an amplitude grating.

3. The method of claim 2, wherein the master grating comprises a chirped grating.

4. The method of claim 3, wherein the recorded volume grating contains a rolled K-vector.

5. The method of claim 1, wherein the recorded volume grating contains a multiplexed grating.

6. The method of claim 1, wherein the master grating comprises three separate gratings.

7. The method of claim 6, wherein the three separate gratings are designed to record an input grating, a fold grating, and an output grating.

8. The method of claim 6, wherein the at least one volume grating comprises three volume gratings.

9. The method of claim 8, wherein the at least one recording beam comprises three recording beams.

10. The method of claim 1, wherein the interferential exposure is formed from the zero order beam and diffracted portion of only one recording beam.

11. The method of claim 1, wherein scanning the at least one recording beam in discrete steps across the aperture of the master grating results in a volume grating vector that rolls in a plane different than the incident plane of the at least one recording beam.

12. A system for recording holographic gratings, the system comprising:
a waveguide cell comprising a layer of polymer dispersed liquid crystal mixture sandwiched between two substrates;
a master grating;
a light source configured to emit at least one recording beam toward the master grating, wherein the at least one recording beam scans in discrete steps and in at least one different angle across an aperture of the master grating,
wherein upon interaction with the master grating, a portion of the at least one recording beam is diffracted towards the waveguide cell and at least one volume grating is recorded within the waveguide cell through interferential exposure formed from at least the diffracted portion of the at least one recording beam.

13. The system of claim 12, wherein the master grating comprises an amplitude grating.

14. The system of claim 13, wherein the master grating comprises a chirped grating.

15. The system of claim 14, wherein the recorded volume grating contains a rolled K-vector.

16. The system of claim 12, wherein the recorded volume grating contains a multiplexed grating.

17. The system of claim 12, wherein the master grating comprises three separate gratings.

18. The system of claim 17, wherein the three separate gratings are designed to record an input grating, a fold grating, and an output grating.

19. The system of claim 17, wherein the at least one volume grating comprises three volume gratings.

20. The system of claim 19, wherein the at least one recording beam comprises three recording beams.

21. The system of claim 12, wherein the interferential exposure is formed from the zero order beam and diffracted portion of only one recording beam.
